(19) United States
(12) Patent Application Publication
(10) Pub. No.: US 2024/0208207 A1
(43) Pub. Date: Jun. 27, 2024

(54) PRINTING DEVICE AND PRINTING METHOD

(71) Applicant: SEIKO EPSON CORPORATION, Tokyo (JP)

(72) Inventor: Tetsuya MATSUMURA, Suwa (JP)

(21) Appl. No.: 18/393,783

(22) Filed: Dec. 22, 2023

(30) Foreign Application Priority Data
Dec. 26, 2022 (JP) 2022-207946

(51) Int. Cl. B41J 2/045; B41J 2/21

(52) U.S. Cl. CPC B41J 2/04558; B41J 2/04573; B41J 2/2132

(57) ABSTRACT

A detection unit includes a sensor that detects a density of locations on a medium on which droplets ejected from a nozzle array during a main scan land while moving along a main scan direction together with a printing head. The detection unit detects landing positions in the main scan direction of the droplets ejected from the nozzle array based on a detection result of the sensor. A control unit controls, based on the landing positions in the main scan direction detected by the detection unit in the first main scan, a timing at which the printing head is caused to eject the droplets in a second main scan to reduce a deviation in the landing position in the main scan direction of the droplets ejected from the nozzle array between the first main scan and the subsequent second main scan.

The present application is based on, and claims priority from JP Application Serial Number 2022-207946, filed Dec. 26, 2022, the disclosure of which is hereby incorporated by reference herein in its entirety.

### BACKGROUND

### 1. Technical Field

The present disclosure relates to a printing device and a printing method for forming a printed image on a medium based on image data.

### 2. Related Art

As a printing device, for example, a serial printer which forms a printed image on a medium while repeating a main scan and a sub-scan is known. The serial printer performs printing for ejecting ink droplets from a nozzle array of a printing head, as droplets, onto a medium while performing a main scan in which the printing head reciprocates along a main scan direction, and performs a sub-scan in which the medium is fed in a feeding direction while the printing is not performed. The feeding direction is a direction opposite to a sub-scan direction which is a relative movement direction of the printing head. In bidirectional printing, ink droplets are ejected from a nozzle array onto a medium in both outward and return routes during main scans.

Since ink droplets are ejected from the nozzle array while the printing head is moving in the main scan direction, a position of the nozzle array at a point in time when the ink droplet is ejected from the nozzle array and a position in which the ink droplet lands on the medium are different in the main scan direction. Therefore, a test pattern is formed on a medium, and an adjustment value corresponding to a distance from an ejection position of the ink droplet to a landing position of the ink droplet is obtained based on the test pattern and stored in a storage unit of the serial printer. The serial printer performs processing of ejecting ink droplets from a nozzle array at a timing according to the adjustment values stored in the storage unit.

JP-A-2022-54901 discloses that an inkjet recording device that performs printing in both directions of a reciprocating scan performs registration processing for adjusting dot recording positions in an outward direction scan and a return direction scan.

The speed of the ink droplets ejected from the nozzle array changes depending on states such as change in viscosity of the ink, change in environmental temperature, and the distance from the nozzle array to the medium. Therefore, a distance from an ink droplet ejection position to an ink droplet landing position changes depending on a state of the printing device, and a position of a ruled line formed in a certain main scan deviates from a position of a ruled line formed in the next main scan. For example, in the bidirectional printing, the position of the ruled line on the outward route and the position of the ruled line on the return route may deviate depending on a change in state.

As described above, with the adjustment value obtained based on the test pattern, it is not possible to curb the deterioration in the image quality of the printed image due to change in the ink droplet landing position depending on the state of the printing device at the time of printing execution.

### SUMMARY

A printing device of the present disclosure is a printing device for forming a printed image on a medium based on image data, the printing device including: a printing head including a nozzle array in which a plurality of nozzles configured to eject a droplet onto the medium are aligned, a control unit configured to control a main scan in which the printing head is moved along a main scan direction intersecting with an alignment direction of the plurality of nozzles, a sub-scan in which at least one of the medium or the printing head is moved along a feeding direction intersecting with the main scan direction, and the ejection of the droplet from the printing head, and a detection unit including a sensor configured to detect a density of a location on the medium at which the droplet ejected from the nozzle array during the main scan lands while moving along the main scan direction together with the printing head, the detection unit being configured to detect a landing position in the main scan direction of the droplet ejected from the nozzle array based on a detection result of the sensor, wherein the control unit controls a plurality of the main scans involving the ejection of the droplet and the sub-scan between the plurality of main scans, based on the image data, the plurality of main scans includes a first main scan and a second main scan subsequent to the first main scan, and the control unit controls, based on the landing position in the main scan direction detected by the detection unit in the first main scan, a timing at which the printing head is caused to eject the droplet in the second main scan to reduce a deviation in the landing position in the main scan direction of the droplet ejected from the nozzle array between the first main scan and the second main scan.

Further, a printing method of the present disclosure is a printing method for forming a printed image on a medium based on image data, the printing method including: a drive step of performing a main scan in which a printing head is moved along a main scan direction intersecting with an alignment direction of a plurality of nozzles in the printing head, the printing head including a nozzle array in which the plurality of nozzles configured to eject a droplet onto the medium are aligned, and a sub-scan in which at least one of the medium or the printing head is moved along a feeding direction intersecting with the main scan direction, a detection step of detecting a landing position of the droplet ejected from the nozzle array in the main scan direction, based on a detection result of a sensor configured to detect a density of a location on the medium on which the droplet ejected from the nozzle array during the main scan lands while moving along the main scan direction together with the printing head, and a control step of controlling a plurality of the main scans involving the ejection of the droplet and the sub-scan between the plurality of main scans, based on the image data, wherein the plurality of main scans include a first main scan and a second main scan subsequent to the first main scan, and the control step includes controlling, based on the landing position in the main scan direction detected in the first main scan, a timing at which the printing head is caused to eject the droplet in the second main scan to reduce a deviation in the landing position of the droplet ejected from the nozzle array in the main scan direction between the first main scan and the second main scan.

### BRIEF DESCRIPTION OF THE DRAWING

FIG. 1 is a diagram schematically illustrating an example of a printing device.

FIG. 2 is a diagram schematically illustrating an example of landing positions of droplets ejected from a nozzle array at the time of a main scan.

FIG. 3 is a plan view schematically illustrating an example of an operation of a printing device that performs a main scan and a sub-scan.

FIG. 4 is a diagram schematically illustrating an example of a landing position when an ejection speed of a droplet is low.

FIG. 5 is a diagram schematically illustrating an example in which a feature portion from which a landing position can be detected is detected from image data.

FIG. 6 is a diagram schematically illustrating an example of a feature portion from which a landing position can be detected.

FIG. 7 is a diagram schematically illustrating an example of a first feature area.

FIG. 8 is a diagram schematically illustrating an example of a second feature area.

FIG. 9 is a diagram schematically illustrating an example of a third feature area.

FIG. 10 is a diagram schematically illustrating an example in which a plurality of feature portions appear in a combination of a first main scan and a second main scan.

FIG. 11 is a diagram schematically illustrating an example in which a droplet ejection timing is controlled through timing change of a drive pulse.

FIG. 12 is a diagram schematically illustrating an example in which the droplet ejection timing is controlled by shifting pixels.

FIG. 13 is a flowchart schematically illustrating an example of printing control processing including adjustment of the droplet ejection timing.

FIG. 14 is a diagram schematically illustrating an example of a feature portion from which a landing position can be detected in unidirectional printing.

FIG. 15 is a diagram schematically illustrating an example of a landing position of a droplet ejected from a nozzle array at the time of a main scan in a printing device including sensors on both sides of a printing head.

FIG. 16 is a flowchart schematically illustrating an example of printing control processing in the printing device including the sensors on both sides of the printing head.

FIG. 17 is a diagram schematically illustrating an example of a feature portion including a fourth feature area which is a high ink amount area.

FIG. 18 is a flowchart schematically illustrating an example of printing control processing for reducing a deviation of a landing position at a position of the feature portion including the fourth feature area which is the high ink amount area.

### DESCRIPTION OF EMBODIMENTS

Hereinafter, embodiments of the present disclosure will be described. Of course, the following embodiments are merely illustrative of the present disclosure, and not all of the characteristics shown in the embodiments are essential to the solution of the disclosure.

### (1) Overview of Technology Included in Present Disclosure

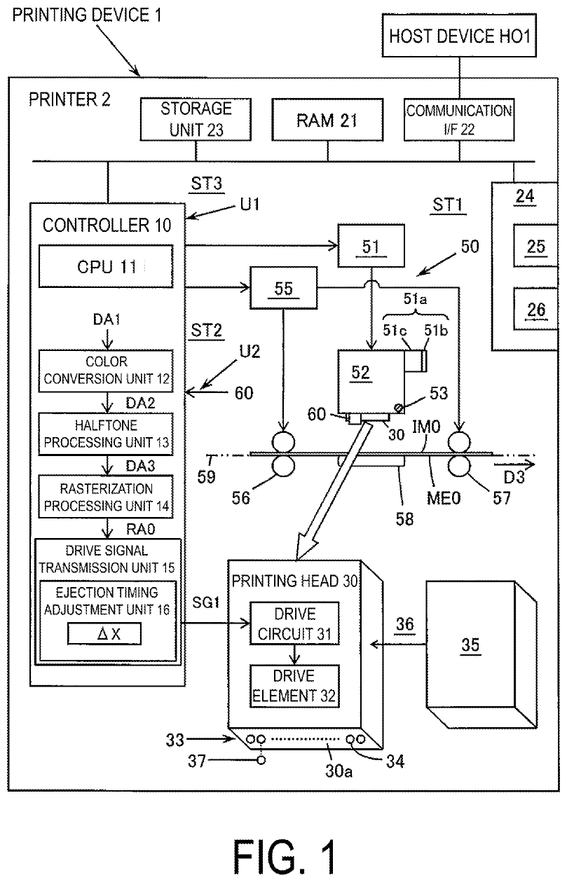

First, an overview of the technology included in the present disclosure will be described with reference to examples illustrated in FIGS. 1 to 18. The figures in this application are diagrams schematically illustrating examples, magnifications in respective directions illustrated in these figures may be different, and the figures may not be consistent. Of course, each element of the present technology is not limited to a specific example indicated by a reference sign. In the “Overview of technology included in present disclosure”, words in parentheses indicate supplementary description of an immediately preceding word.

### Aspect 1

As illustrated in FIGS. 1 to 3 and the like, a printing device 1 according to an aspect of the present technology is a printing device 1 that forms a printed image IM0 on a medium ME0 based on image data (for example, ink amount data DA2 and dot data DA3), and includes a printing head 30, a control unit U1, and a detection unit U2. The printing head 30 includes a nozzle array 33 in which a plurality of nozzles 34 configured to eject a droplet 37 onto the medium ME0 are aligned. The control unit U1 controls a main scan S0 in which the printing head 30 is moved along a main scan direction D1 intersecting with an alignment direction D4 of the plurality of nozzles 34, a sub-scan in which at least one of the medium ME0 or the printing head 30 is moved along a feeding direction D3 intersecting with the main scan direction D1, and the ejection of the droplet 37 from the printing head 30. The detection unit U2 includes a sensor 60 that detects a density of locations on the medium ME0 on which the droplets 37 ejected from the nozzle array 33 during the main scan S0 land while moving along the main scan direction D1 together with the printing head 30, and detects a landing position X2 in the main scan direction D1 of the droplet 37 ejected from the nozzle array 33 based on a detection result of the sensor 60. The control unit U1 controls a plurality of the main scans S0 involving the ejection of the droplets 37 and the sub-scan between the main scans S0, based on the image data. Here, the plurality of main scans S0 include a first main scan S1 and a second main scan S2 subsequent to the first main scan S1. The control unit U1 controls the timing at which the printing head 30 is caused to eject the droplets 37 in the second main scan S2 so that the deviation of the landing position X2 in the main scan direction D1 of the droplet 37 ejected from the nozzle array 33 between the first main scan S1 and the second main scan S2 is reduced, based on the landing position X2 in the main scan direction D1 detected by the detection unit U2 in the first main scan S1.

As described above, the deviation of the landing position X2 of the droplet 37 ejected from the nozzle array 33 in the main scan direction D1 between the first main scan S1 and the second main scan S2 for forming one printed image IM0 is reduced. Therefore, in the above aspect, it is possible to curb deterioration in the image quality of the printed image due to change in the landing position of the droplets during the use of the printing device.

Here, the control unit may perform control for moving the medium along the feeding direction without moving the printing head during sub-scan, perform control for moving the printing head along the feeding direction without moving the medium, or perform control for moving both the medium and the printing head along the feeding direction.

In the present application, “first”, “second”, or the like are terms for identifying each component included in a plurality of components having similarity, and do not mean an order. Which of the plurality of components applies to “first”, “second”, or the like is determined relatively.

The above-described additional remarks are also applied to the following aspects.

### Aspect 2

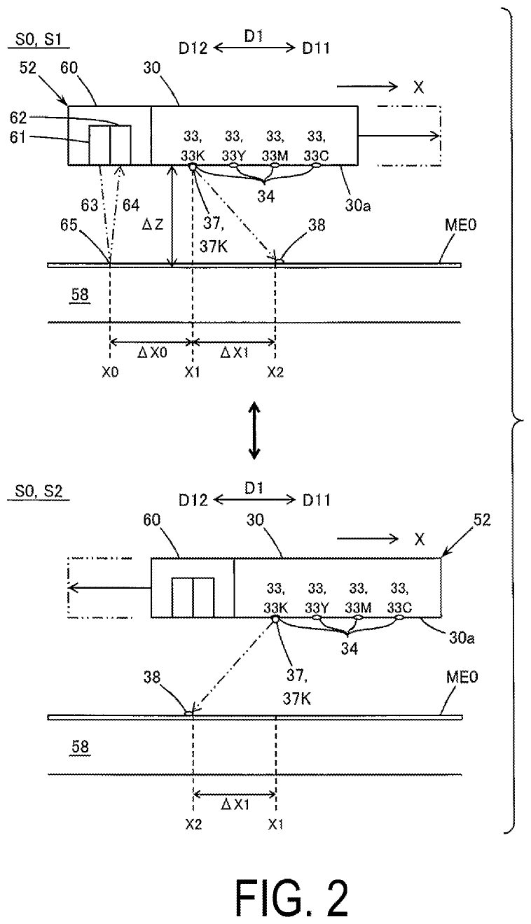

As illustrated in FIGS. 2, 3, 14, and the like, there may be the second main scan S2 subsequent to the first main scan S1 in the plurality of main scans S0 involving the ejection of the droplets 37.

In the above case, the deviation of the landing position X2 in the main scan direction D1 of the droplet 37 ejected from the nozzle array 33 in the first main scan S1 and then in the second main scan S2 is reduced. Therefore, in the above aspect, it is possible to further curb deterioration in the image quality of the printed image due to change in the landing position of the droplets during the use of the printing device.

### Aspect 3

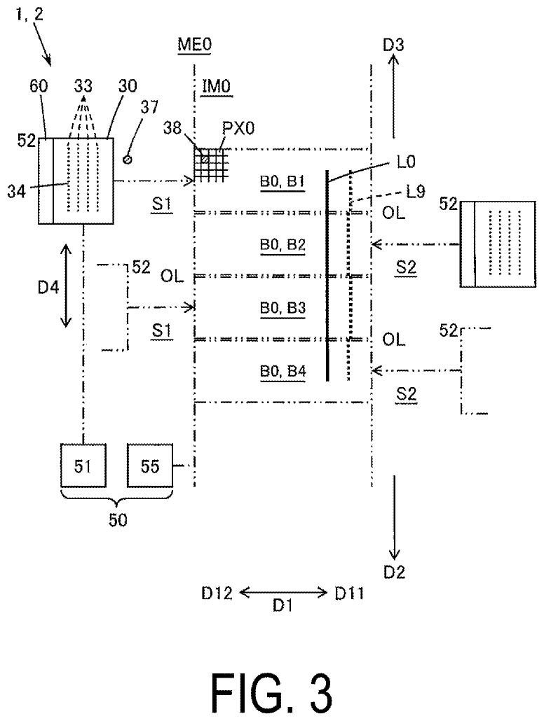

As illustrated in FIGS. 2, 3, and the like, the control unit U1 may move the printing head 30 in a first direction (for example, an outward direction D11) in the first main scan S1, and move the printing head 30 in a second direction (for example, a return direction D12) opposite to the first direction (D11) in the second main scan S2. The sensor 60 may be at a position toward the second direction (D12) from the printing head 30.

In the above case, the density of the locations at which the droplet 37 ejected from the printing head 30 moving in the first direction (D11) lands on the medium ME0 in the first main scan S1 is easily detected by the sensor 60, and the deviation of the landing position X2 in the main scan direction D1 of the droplet 37 ejected from the nozzle array 33 between the main scans S0 in which moving directions of the printing head 30 are different from each other is reduced. Therefore, in the above aspect, it is possible to further curb deterioration in the image quality of the printed image due to change in the landing position of the droplets during the use of the printing device that performs bidirectional printing.

### Aspect 4

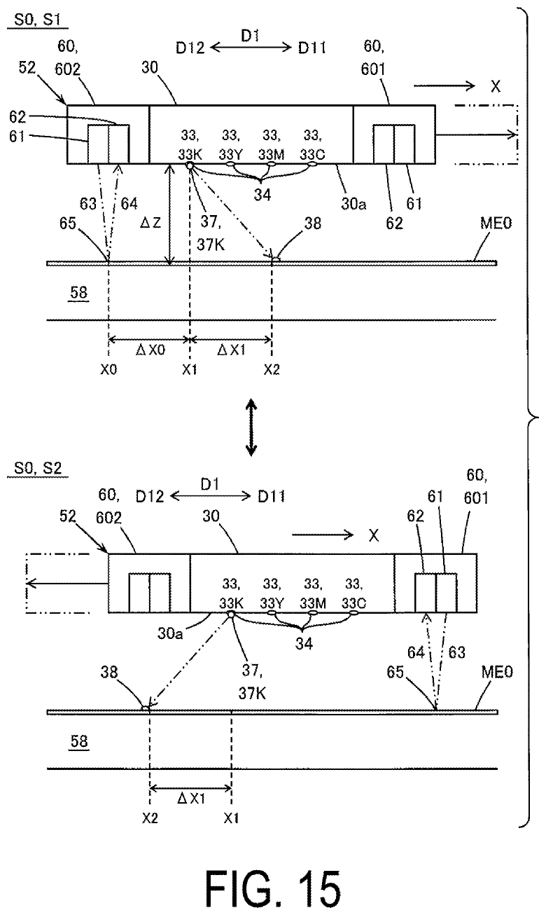

In the printing device 1 that performs bidirectional printing, the plurality of main scans S0 involving the ejection of the droplet 37 may alternately include the first main scan S1 and the second main scan S2. The sensors 60 may include a first direction side sensor 601 at a position toward the first direction (D11) from the printing head 30, and a second direction side sensor 602 at a position toward the second direction (D12) from the printing head 30, as illustrated in FIG. 15. The control unit U1 may control the timing at which the printing head 30 is caused to eject the droplets 37 in the second main scan S2 so that the deviation of the landing position X2 of the droplet 37 ejected from the nozzle array 33 in the main scan direction D1 between the first main scan S1 and the second main scan S2 is reduced, based on the landing position X2 in the main scan direction D1 detected by the second direction side sensor 602 in the first main scan S1. The control unit U1 may control a timing at which the printing head 30 is caused to eject the droplets 37 in the first main scan S1 so that the deviation of the landing position X2 in the main scan direction D1 of the droplet 37 ejected from the nozzle array 33 between the second main scan S2 and the first main scan S1 is reduced, based on the landing position X2 in the main scan direction D1 detected by the first direction side sensor 601 in the second main scan S2.

In the above case, in the main scan direction D1, the landing position X2 of the droplet 37 in the second main scan S2 in which the printing head 30 moves in the second direction (D12) is matched with the landing position X2 of the droplet 37 in the first main scan S1 in which the printing head 30 moves in the first direction (D11), and the landing position X2 of the droplet 37 in the first main scan S1 in which the printing head 30 moves in the first direction (D11) is matched with the landing position X2 of the droplet 37 in the second main scan S2 in which the printing head 30 moves in the second direction (D12). Therefore, in the above aspect, it is possible to further curb deterioration in the image quality of the printed image due to change in the landing position of the droplets during the use of the printing device that performs the bidirectional printing.

### Aspect 5

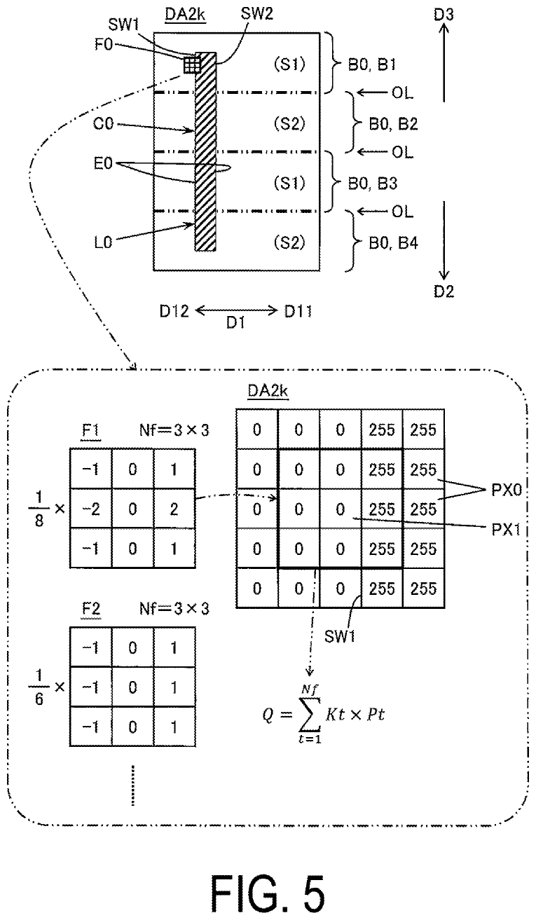

As illustrated in FIGS. 5 to 9, and the like, the control unit U1 may extract a feature portion C0 from which the landing position X2 can be detected, from a portion in which the printed image IM0 is formed in the first main scan S1 in the image data. The control unit U1 may control the timing at which the printing head 30 is caused to eject the droplets 37 in the second main scan S2 so that the deviation of the landing position X2 of the droplet 37 ejected from the nozzle array 33 in the main scan direction D1 between the first main scan S1 and the second main scan S2 is reduced, based on the landing position X2 in the main scan direction D1 detected by the detection unit U2 at a position of the feature portion C0 in the first main scan S1. In the above aspect, it is possible to provide a suitable example of curbing the deterioration in the image quality of the printed image due to change in the landing position of the droplets during the use of the printing device.

Here, the feature portion C0 may include an edge E0 intersecting with the main scan direction D1 in the image data. Since the density of the printed image IM0 suddenly changes at a position of the edge E0, it is easy to detect the landing position X2 at the position of the edge E0 intersecting with the main scan direction D1. Therefore, in an aspect in which the feature portion C0 is the edge E0, it is possible to further curb deterioration in the image quality of the printed image due to change in the landing position of the droplets during the use of the printing device.

### Aspect 6

As illustrated in FIGS. 5 to 7, and the like, in the printing device 1 that performs bidirectional printing, the feature portion C0 may include a switching portion SW2 that is coupled from a portion in which the printed image IM0 is formed in the first main scan S1 to a portion in which the printed image IM0 is formed in the second main scan S2, and in which the ejection state of the droplet 37 changes from ejection to non-ejection in the first main scan S1 and changes from non-ejection to ejection in the second main scan S2. The control unit U1 may control the timing at which the printing head 30 is caused to eject the droplets 37 in the second main scan S2 so that the landing position X2 in the main scan direction D1 of the switching portion SW2 in the second main scan S2 approaches the landing position X2 in the main scan direction D1 of the switching portion SW2 in the first main scan S1, based on the landing position X2 in the main scan direction D1 detected by the detection unit U2 at the position of the switching portion SW2 in the first main scan S1. In the present aspect, it is possible to provide a suitable example of curbing the deterioration in the image quality of the printed image due to change in the landing position of the droplets during the use of the printing device that performs the bidirectional printing.

### Aspect 7

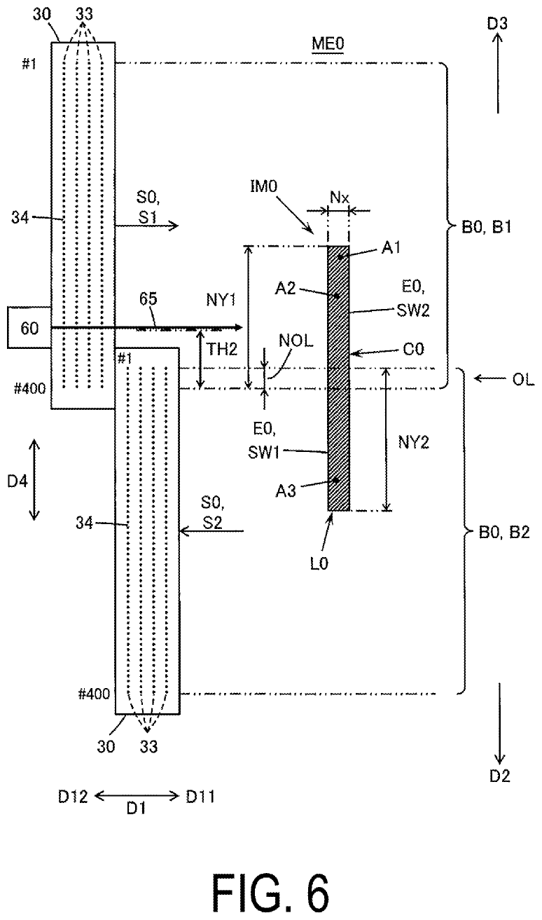

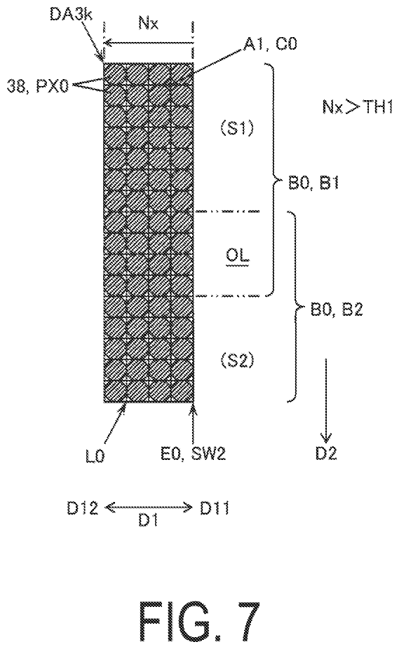

As illustrated in FIGS. 6 and 7, in the printing device 1 that performs the bidirectional printing, the feature portion C0 may include a first feature area A1 in which a number Nx of the droplet 37 larger than a first threshold value TH1 land on the medium ME0 continuously in the second direction (D12) from the switching portion SW2 in the first main scan S1. The control unit U1 may control the timing at which the printing head 30 is caused to eject the droplets 37 in the second main scan S2 so that the landing position X2 in the main scan direction D1 of the switching portion SW2 in the second main scan S2 approaches the landing position X2 in the main scan direction D1 of the switching portion SW2 in the first main scan S1, based on the landing position X2 in the main scan direction D1 detected by the detection unit U2 at the position of the switching portion SW2 in the first main scan S1, for the switching portion SW2 coupled to the first feature area A1. When the droplet 37 is ejected continuously in the main scan direction D1 from the printing head 30 moving along the main scan direction D1, the first ejected droplet 37 is affected by a surrounding airflow, and wind generated by itself serves as a wind shield for the droplet 37 that is ejected later. Therefore, the ejection characteristics of the subsequent droplet 37 are stabilized. In the first main scan S1, since the switching portion SW2 in which the number Nx of droplets 37 larger than the first threshold value TH1 are not ejected after the droplets 37 are ejected from the nozzle array 33 appears in the first feature area A1, the detection accuracy of the landing position X2 is improved. Therefore, in the above aspect, it is possible to further curb deterioration in the image quality of the printed image due to change in the landing position of the droplets during the use of the printing device.

### Aspect 8

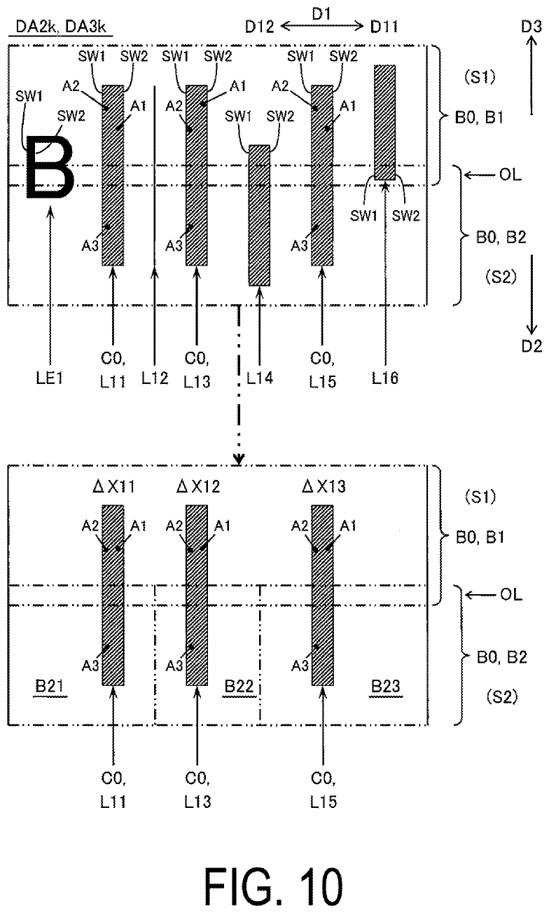

As illustrated in FIG. 10 and the like, the control unit U1 may not set a letter LE1 of the image data as the feature portion C0.

For the letter LE1, the deviation of the landing position X2 between the main scans S0 is not noticeable. It becomes possible to improve the image quality of the printed image more easily than when the letter is the target by excluding the letter LE1 from a target of reduction in the deviation of the landing position X2.

### Aspect 9

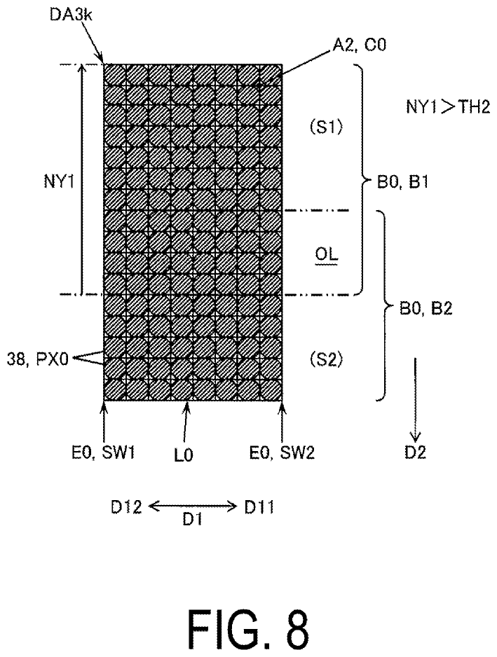

As illustrated in FIGS. 6 and 8, the feature portion C0 may include a second feature area A2 in which a number of droplets 37 larger than a second threshold value TH2 land on the medium ME0 continuously in the feeding direction D3 in the switching portions SW1 and SW2 in which the ejection state of the droplet 37 changes between ejection and non-ejection in the first main scan S1. The control unit U1 may control the timing at which the printing head 30 is caused to eject the droplets 37 in the second main scan S2 so that the deviation of the landing position X2 of the droplet 37 ejected from the nozzle array 33 in the main scan direction D1 between the first main scan S1 and the second main scan S2 is reduced, based on the landing position X2 in the main scan direction D1 detected by the detection unit U2 at the position of the second feature area A2 in the first main scan S1.

The droplets 37 ejected from an end portion in the feeding direction D3 of the printing head 30 moving along the main scan direction D1 are affected by the surrounding airflow, and the droplets 37 ejected from a portion on an inner side of the above-described end portion in the printing head 30 are less likely to be affected by a surrounding airflow. Therefore, the ejection characteristics of the droplet 37 from the above-described portion on the inner side in the printing head 30 are stabilized. In the first main scan S1, since the droplet 37 ejected from the above-described inner portion in the printing head 30 lands in the second feature area A2, the detection accuracy of the landing position X2 is improved. Therefore, in the above aspect, it is possible to further curb deterioration in the image quality of the printed image due to change in the landing position of the droplets during the use of the printing device.

### Aspect 10

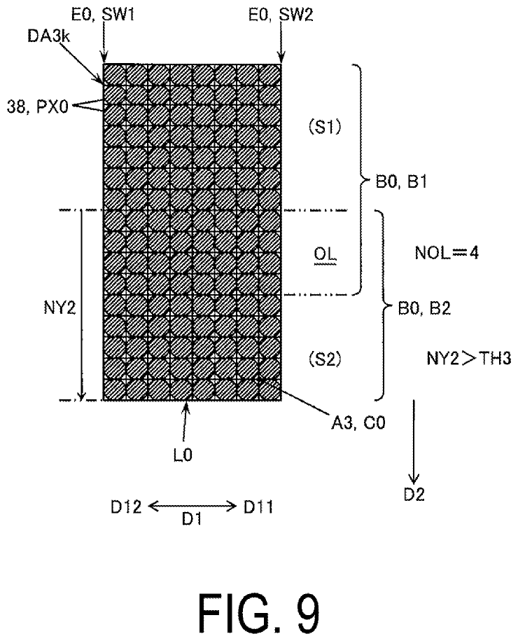

As illustrated in FIGS. 6 and 9, the feature portion C0 may include a third feature area A3 coupled from a portion in which the printed image IM0 is formed in the first main scan S1 to a portion in which the printed image IM0 is formed in the second main scan S2, the third feature area A3 being a third feature area A3 in which a number of droplets 37 larger than a third threshold value TH3 land on the medium ME0 continuously in the feeding direction D3 in the switching portions SW1 and SW2 in which the ejection state of the droplet 37 changes between ejection and non-ejection in the second main scan S2. The control unit U1 may control the timing at which the printing head 30 is caused to eject the droplets 37 in the second main scan S2 so that the landing position X2 in the main scan direction D1 of the third feature area A3 in the second main scan S2 approaches the landing position X2 in the main scan direction D1 of the third feature area A3 in the first main scan S1, based on the landing position X2 in the main scan direction D1 detected by the detection unit U2 at the position of the third feature area A3 in the first main scan S1.

When the target of reduction in the deviation of the landing position X2 is short in the feeding direction D3, the deviation of the landing position X2 between the main scans S0 is not noticeable, and when the target of reduction in the deviation of the landing position X2 is long in the feeding direction D3, the deviation of the landing position X2 between the main scans S0 is noticeable. Therefore, in the above aspect, it is possible to provide a suitable example of curbing the deterioration in the image quality of the printed image due to change in the landing position of the droplets during the use of the printing device.

### Aspect 11

As illustrated in FIG. 2 and the like, the printing head 30 may be configured to eject a black droplet 37K having a black color as the droplet 37. The control unit U1 may control the timing at which the printing head 30 is caused to eject the droplets 37 in the second main scan S2 so that the deviation of the landing position X2 in the main scan direction D1 of the black droplet 37K ejected from the nozzle array 33 between the first main scan S1 and the second main scan S2 is reduced, based on the landing position X2 of the black droplet 37K in the main scan direction D1 detected by the detection unit U2 in the first main scan 51.

Since black dots provide higher visibility than non-black dots, deviation of the landing position X2 is likely to affect the image quality of the printed image IM0. The target of reduction in the deviation of the landing position X2 is set as the black droplet 37K, making it possible to improve the image quality of the printed image more easily than when droplets with all colors are a target.

### Aspect 12

As illustrated in FIG. 2 and the like, the printing head 30 may be configured to eject, as the droplet 37, the black droplet 37K having a black color and color droplets with a plurality of colors configured to form the composite black. The control unit U1 may not set a composite black portion in the image data as the feature portion C0.

The composite black easily bleeds because a total amount of ejected liquid increases, and the deviation of the landing position X2 between the main scans S0 is not noticeable. It becomes possible to improve the image quality of the printed image more easily than when the composite black is a target by excluding the composite black from the target of reduction in the deviation of the landing position X2.

### Aspect 13

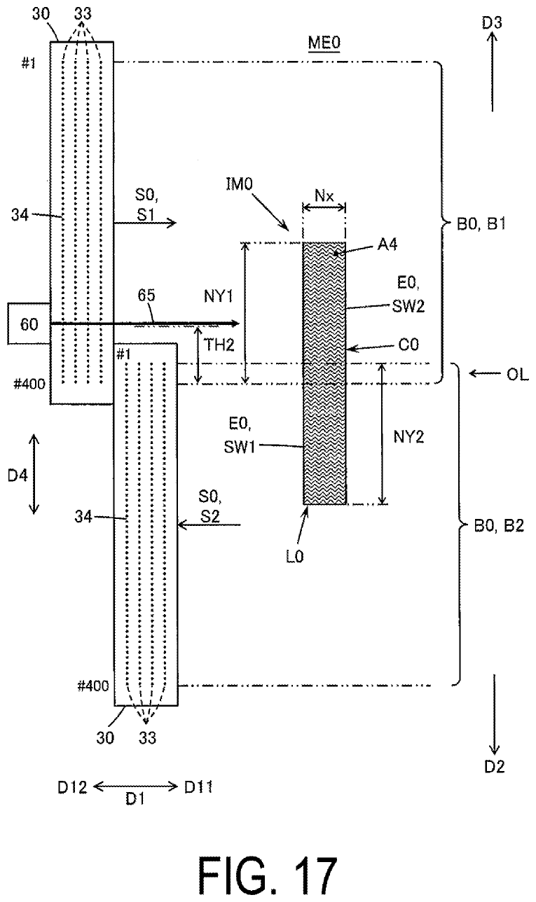

As illustrated in FIG. 17, the feature portion C0 may include a fourth feature area A4 in which an amount of droplets 37 larger than a predetermined amount per unit area land on the medium ME0 continuously in the main scan direction D1 from the switching portions SW1 and SW2 in which the ejection state of the droplet 37 changes between ejection and non-ejection in the first main scan S1. The control unit U1 may control the timing at which the printing head 30 is caused to eject the droplets 37 in the second main scan S2 so that the deviation of the landing position X2 of the droplet 37 ejected from the nozzle array 33 in the main scan direction D1 between the first main scan S1 and the second main scan S2 is reduced, based on the landing position X2 in the main scan direction D1 detected by the detection unit U2 at the position of the fourth feature area A4 in the first main scan S1.

In the fourth feature area A4 on which more droplets 37 than a predetermined amount per unit area land on the medium ME0, an undulation (including wrinkle) called cockling is likely to occur in the medium ME0 due to the influence of a large amount of droplet 37, and the deviation of the landing position X2 may be different from other locations. Such a fourth feature area A4 is used as the target of reduction in the deviation of the landing position X2, such that the deviation of the landing position X2 is reduced and the image quality of the printed image IM0 can be improved even when undulation occurs in the medium ME0.

### Aspect 14

Further, a printing method according to an aspect of the present technology is a printing method for forming the printed image IM0 on the medium ME0 based on image data, and includes the following steps as illustrated in FIG. 1.
(A1) A drive step ST1 of performing the main scan S0 in which the printing head 30 is moved along the main scan direction D1 intersecting with an alignment direction D4 of the plurality of nozzles 34 in the printing head 30 including the nozzle array 33 in which the plurality of nozzles 34 configured to eject the droplets 37 onto the medium ME0 are aligned, and a sub-scan in which at least one of the medium ME0 or the printing head 30 is moved along the feeding direction D3 intersecting with the main scan direction D1.
(A2) A detection step ST2 of detecting the landing position X2 of the droplet 37 ejected from the nozzle array 33 in the main scan direction D1, based on a detection result of the sensor 60 that detects a density of the locations on the medium ME0 on which the droplets 37 ejected from the nozzle array 33 during the main scan S0 land while moving along the main scan direction D1 together with the printing head 30.
(A3) A control step ST3 of controlling a plurality of the main scans S0 involving the ejection of the droplet 37 and the sub-scan between the main scans S0, based on the image data.

Here, the plurality of main scans S0 include a first main scan S1 and a second main scan S2 subsequent to the first main scan S1. In this printing method, in the control step ST3, the timing at which the printing head 30 is caused to eject the droplets 37 in the second main scan S2 is controlled so that the deviation of the landing position X2 of the droplet 37 ejected from the nozzle array 33 in the main scan direction D1 between the first main scan S1 and the second main scan S2 is reduced, based on the landing position X2 in the main scan direction D1 detected in the first main scan S1.

In the above aspect, it is possible to also curb deterioration in the image quality of the printed image due to change in the landing position of the droplets during the use of the printing device.

Further, the present technology can be applied to a printing system including the above-described printing device, a control method for the above-described printing device, a control method for the above-described printing system, a control program for the above-described printing device, a control program for the above-described printing system, and a computer-readable recording medium on which such a control program is recorded. Further, the above-described printing device may be configured of a plurality of distributed parts.

### (2) Specific Example of Printing Device Including Printing Device

FIG. 1 schematically illustrates a printing device 1. Although the printing device 1 in this specific example is the printer 2 itself, the printing device 1 may be a combination of the printer 2 and a host device HO1. The printer 2 illustrated in FIG. 1 is a serial printer that is a type of inkjet printer that ejects ink droplets as droplets 37. The printer 2 may include additional elements not illustrated in FIG. 1. FIG. 2 schematically illustrates the landing position X2 of the droplet 37 ejected from the nozzle array 33 at the time of a main scan. The landing position X2 of the droplet 37 in the main scan S0 of the outward route which is an example of the first main scan S1 is illustrated on the upper side of FIG. 2, and the landing position X2 of the droplet 37 in the main scan S0 of the return route which is an example of the second main scan S2 subsequent to the first main scan S1 is illustrated the lower side of FIG. 2. FIG. 3 schematically illustrates an operation of the printer 2 that performs a main scan and a sub-scan.

The printer 2 illustrated in FIG. 1 includes a controller 10, a RAM 21 that is a semiconductor memory, a communication I/F 22, a storage unit 23, an operating panel 24, a printing head 30, a drive unit 50, a sensor 60 that detects the density of the medium ME0, and the like. Here, the RAM is an abbreviation for Random Access Memory, and I/F is an abbreviation for interface. The controller 10 is an example of the control unit U1, and the sensor 60 and the controller 10 are an example of the detection unit U2 that detects the landing position X2 of the droplet 37. The controller 10, the RAM 21, the communication I/F 22, the storage unit 23, and the operating panel 24 are coupled to a bus and are capable of inputting and outputting information to and from each other.

The controller 10 includes a CPU 11 which is a processor, a color conversion unit 12, a halftone processing unit 13, a rasterization processing unit 14, a drive signal transmission unit 15, and the like. Here, the CPU is an abbreviation for Central Processing Unit. The controller 10 controls the main scan and sub-scan by the drive unit 50 and the ejection of the droplet 37 by the printing head 30 based on original image data DA1 acquired from any one of the host device HO1, a memory card (not illustrated), and the like. RGB data having an integer value of 2⁸ gradations or 2¹⁶ gradations of R, G, and B for each pixel, for example, can be applied to the original image data DA1. Here, R indicates red, G indicates green, and B indicates blue. When the letter LE1 (see FIG. 10) is included in the original image data DA1, the controller 10 also acquires letter range information indicating a range of the letter LE1 from the original image data DA1. The controller 10 performs the control step ST3.

The controller 10 may be configured of an SoC or the like. Here, SoC is an abbreviation for System on a Chip.

The CPU 11 is a device that mainly performs information processing or control in the printer 2.

The color conversion unit 12 refers to, for example, a color conversion LUT that defines a correspondence relationship between R, G, and B gradation values and C, M, Y, and K gradation values, and converts RGB data into the ink amount data DA2 having an integer value of 2⁸ gradations or 2¹⁶ gradations of C, M, Y, and K for each pixel. Here, C means cyan, M means magenta, Y means yellow, K means black, and LUT is an abbreviation for lookup table. The ink amount data DA2 represents a use amount of C, M, Y, and K liquids 36 in units of pixels PX0 (see FIG. 5). Further, when the resolution of the RGB data is different from printing resolution, the color conversion unit 12 first converts the resolution of the RGB data to the printing resolution, or converts the resolution of the ink amount data DA2 to the printing resolution.

The halftone processing unit 13 performs halftone processing using any one of a dither method, an error diffusion method, and the like on a gradation value of each pixel PX0 constituting the ink amount data DA2 of each color, thereby reducing a gradation number of the gradation value and generating the dot data DA3. The dot data DA3 represents a formation state of a dot 38 of the droplet 37 in units of pixels PX0. The dot data DA3 may be binary data indicating whether a dot is formed, or may be multi-value data of three or more gradations that can correspond to dots with different sizes, such as small, medium and large dots. The ink amount data DA2 and dot data DA3 of the printing resolution are examples of image data for forming the printed image IM0 on the medium ME0. The printed image IM0 of this specific example does not include a test pattern.

The rasterization processing unit 14 generates raster data RAO by performing rasterization processing in which the dot data DA3 is rearranged in an order in which the dots 38 are formed by the drive unit 50.

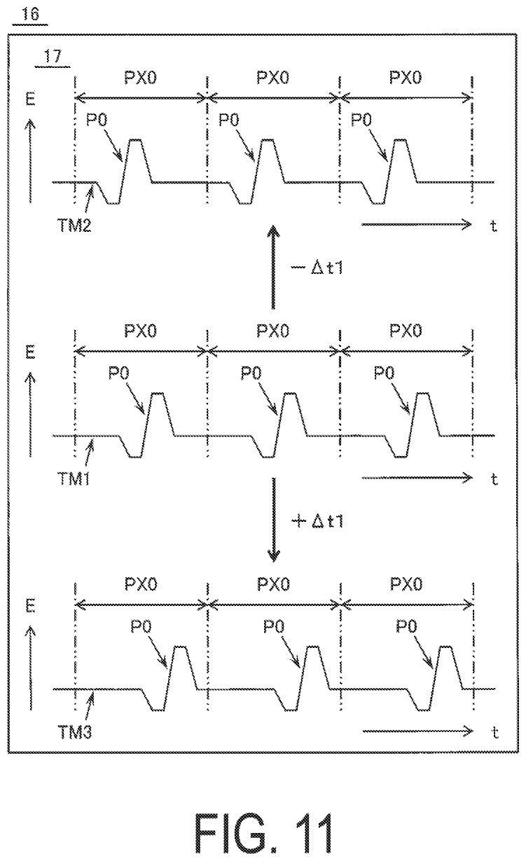

The drive signal transmission unit 15 includes an ejection timing adjustment unit 16 that matches the ejection of the droplets 37 with a timing according to an adjustment value ΔX for determining a position X1 (see FIG. 2) of the printing head 30 at a point in time when the droplets 37 are ejected from the nozzle array 33 in each main scan. The ejection timing adjustment unit 16 can adjust an ejection timing of the droplet 37 more finely than the pixel PX0 in the drive pulse timing adjustment unit 17 illustrated in FIG. 11, in other words, more finely than the printing resolution. Details of the adjustment value ΔX will be described below.

The drive signal transmission unit 15 generates a drive signal SG1 from the raster data RAO at a timing according to the adjustment value ΔX, and outputs the drive signal SG1 to the drive circuit 31 of the printing head 30. The drive signal SG1 corresponds to a voltage signal applied to the drive element 32 of the printing head 30. For example, when the raster data RAO is “dot formation”, the drive signal transmission unit 15 outputs the drive signal SG1 for causing droplets for dot formation to be ejected. Furthermore, when the raster data RAO is four-value data, the drive signal transmission unit 15 outputs the drive signal SG1 for causing droplets for a large dot to be ejected when the raster data RAO is “large dot formation”, outputs the drive signal SG1 for causing droplets for a medium dot to be ejected when the raster data RAO is “medium dot formation”, and outputs a drive signal SG1 for causing droplets for a small dot to be ejected when the raster data RAO is “small dot formation”.

Each of the units 11 to 15 may be configured of an ASIC, and may directly read data that is a processing target from the RAM 21 or directly write processed data to the RAM 21. Here, the ASIC is an abbreviation for Application Specific Integrated Circuit.

The drive unit 50 controlled by the controller 10 includes a carriage drive unit 51 and a roller drive unit 55. The drive unit 50 causes a carriage 52 to reciprocate along the main scan direction D1 according to driving of the carriage drive unit 51, and feeds the medium ME0 in the feeding direction D3 along a transport path 59 according to driving of the roller drive unit 55. As illustrated in FIGS. 2 and 3, the main scan direction D1 collectively refers to an outward direction D11 which is an example of the first direction, and a return direction D12 which is an example of the second direction opposite to the first direction. As illustrated in FIG. 3, the main scan direction D1 is a direction intersecting with the alignment direction D4 of the nozzles 34, and is, for example, a direction orthogonal to the alignment direction D4. The feeding direction D3 is a direction intersecting with the main scan direction D1, and is, for example, a direction orthogonal to the main scan direction D1. In FIG. 1, the feeding direction D3 is a right direction, a left side is referred to as an upstream, and a right side is referred to as a downstream. A sub-scan direction D2 illustrated in FIG. 3 is a direction opposite to the feeding direction D3. The drive unit 50 performs a drive step ST1 in which the main scan and the sub-scan are performed.

The carriage drive unit 51 is configured of a servo motor, and reciprocates the carriage 52 along the main scan direction D1 under the control of the controller 10. It can be said that the carriage drive unit 51 performs the main scan for moving the printing head 30 along the main scan direction D1, and the controller 10 controls the main scan. The roller drive unit 55 includes a transport roller pair 56 and a discharge roller pair 57. The roller drive unit 55 is configured of a servo motor, and performs a sub-scan for feeding the medium ME0 in the feeding direction D3 by rotating a driving transport roller of the transport roller pair 56 and a driving discharge roller of the discharge roller pair 57 under the control of the controller 10. It can be said that the roller drive unit 55 performs a sub-scan for moving at least one of the medium ME0 or the printing head 30 along the feeding direction D3, and the controller 10 controls the sub-scan. The control unit U1 exemplified by the controller 10 may include a dedicated main scan control unit that controls the main scan, and a dedicated sub-scan control unit that controls the sub-scan.

The medium ME0 is a material that holds the printed image, and is made of paper, resin, metal, or the like. The material of the medium ME0 is not particularly limited, and various materials such as resin, metal, and paper can be considered. A shape of the medium ME0 is also not particularly limited, and various shapes such as a rectangle and a roll shape can be considered, and a three-dimensional shape may be used.

The carriage drive unit 51 includes a linear encoder 51a to detect a position of the carriage 52 in the main scan direction D1. The linear encoder 51a includes a linear scale 51b in which a large number of slits are formed at regular intervals, and a linear scale sensor 51c provided on the carriage 52. The linear scale sensor 51c optically reads each slit of the linear scale 51b and outputs a detection signal containing a number of pulses proportional to a movement distance of the carriage 52 in the main scan direction D1. The carriage drive unit 51 detects the position X of the carriage 52 in the main scan direction D1 based on the detection signal of the linear scale sensor 51c.

The printing head 30 and the sensor 60 are mounted on the carriage 52. A liquid cartridge 35 that supplies the printing head 30 with a liquid 36 such as ink that is ejected as the droplet 37 may be mounted on the carriage 52. Of course, the liquid 36 may be supplied from the liquid cartridge 35 installed outside the carriage 52 to the printing head 30 via a tube. The carriage 52 is fixed to an endless belt (not illustrated) and is movable in the main scan direction D1 along a guide 53. The guide 53 is an elongated member of which a longitudinal direction is directed in the main scan direction D1.

A platen 58 is below the transport path 59 and supports the medium ME0 by coming into contact with the medium ME0 that is on the transport path 59. The printing head 30 controlled by the controller 10 attaches the liquid 36 on the medium ME0 by ejecting droplets 37 toward the medium ME0 supported by the platen 58.

The printing head 30 including a drive circuit 31, a drive element 32, or the like includes the plurality of nozzles 34 capable of ejecting the droplets 37 on a nozzle surface 30a, and performs printing by ejecting the droplets 37 onto the medium ME0 on the platen 58. Here, the nozzle means a small hole through which droplets are ejected, and the nozzle array means an alignment of a plurality of nozzles. The nozzle surface 30a is a surface from which the droplets 37 are ejected. The drive circuit 31 applies the voltage signal to the drive element 32 according to the drive signal SG1 input from the drive signal transmission unit 15. As the drive element 32, a piezoelectric element that applies pressure to the liquid 36 in a pressure chamber communicating with the nozzles 34, a drive element that generates air bubbles in the pressure chamber by heat to cause the droplet 37 to be ejected from the nozzles 34, or the like can be used. The liquid 36 is supplied from the liquid cartridge 35 to the pressure chamber of the printing head 30. The liquid 36 in the pressure chamber is ejected as the droplet 37 toward the medium ME0 from the nozzle 34 by the drive element 32. Accordingly, the dot 38 of the droplet 37 is formed on the medium ME0. While the printing head 30 moves in the main scan direction D1, the dot 38 according to the raster data RAO is formed, and the medium ME0 is repeatedly fed in the feeding direction D3 by one sub-scan so that the printed image IM0 is formed on the medium ME0.

The RAM 21 stores the original image data DA1 and the like received from the host device HO1, a memory (not illustrated), and the like. The communication I/F 22 is coupled to the host device HO1 by wire or wirelessly, and inputs and outputs information to and from the host device HO1. The host device HO1 includes a computer such as a personal computer or a tablet terminal, a mobile phone such as a smartphone, a digital camera, a digital video camera, and the like. For the storage unit 23, a nonvolatile semiconductor memory such as a flash memory, a magnetic storage device such as a hard disk, or the like can be used. The operating panel 24 includes an output unit 25 such as a liquid crystal panel that displays information, an input unit 26 such as a touch panel that receives operations related to a display screen, and the like.

The printing head 30 illustrated in FIG. 2 is mounted on the carriage 52 and includes, on the nozzle surface 30a, a plurality of nozzle arrays 33 each including the plurality of nozzles 34 aligned at intervals with a predetermined nozzle pitch in the alignment direction D4. The plurality of nozzle arrays 33 include a cyan nozzle array 33C that ejects C droplets 37, a magenta nozzle array 33M that ejects M droplets 37, a yellow nozzle array 33Y that ejects Y droplets 37, a K nozzle array 33Y that ejects Y droplets 37, and a black nozzle array 33K that ejects the black droplets 37K, which are K droplet 37. Therefore, the printing head 30 is capable of ejecting, as the droplets 37, the black droplets 37K having a black color, and color droplets with a plurality of colors capable of forming the composite black in which C, M, and Y are mixed. Each droplet 37 is ejected from the nozzle 34 for the pixel PX0 of the medium ME0. Of course, the C dot 38 is formed on the medium ME0 from the C droplet 37, the M dot 38 is formed on the medium ME0 from the M droplet 37, the Y dot 38 is formed on the medium ME0 from the Y droplet 37, and the K dot 38 is formed on the medium ME0 from the black droplet 37K. Each nozzle array 33 ejects the droplet 37 toward the medium ME0. The plurality of nozzles 34 included in each nozzle array 33 may be aligned in a single row, or may be aligned in a staggered pattern, that is, in two rows.

The sensor 60 illustrated in FIG. 2 is also mounted on the carriage 52. Therefore, a position of the sensor 60 relative to the printing head 30 remains unchanged. The sensor 60 illustrated in FIG. 2 is a reflective optical sensor including a light-emitting unit 61 and a light reception unit 62, and is at a position toward the return direction D12 from the printing head 30. The light-emitting unit 61 emits light 63 to a location on a surface of the medium ME0 on which the droplet 37 ejected from the nozzle array 33 during the main scan S0 land. The light reception unit 62 detects light 64 reflected from the surface of the medium ME0, and transmits an electrical signal indicating the intensity of the detected light, for example, a detected voltage, to the controller 10 illustrated in FIG. 1. A location on the surface of the medium ME0 that is irradiated with the light 63 includes a detection range 65 of the reflected light 64 by the light reception unit 62. The sensor 60 of this specific example includes an analog/digital conversion circuit that converts an analog amount of the detected voltage of the light reception unit 62 into a digital value, and the sensor 60 converts the analog amount of the detected voltage of the light reception unit 62 into the digital value with the analog/digital conversion circuit, and outputs the digital value to the controller 10. When the surface of the medium ME0 is darker, the reflected light 64 is weaker, and thus, the sensor 60 transmits an electrical signal indicating the intensity of the detected light which becomes weaker as a surface density of the medium ME0 becomes higher, for example, a detected voltage which becomes lower as the surface density of the medium ME0 becomes higher, to the controller 10. For example, when the medium ME0 has a light color such as white, the reflected light 64 is strong, and thus, the sensor 60 transmits an electrical signal indicating that the surface density of the medium ME0 is low, for example, a high detected voltage, to the controller 10. When dark-colored dots 38 such as black dots are formed on the medium ME0, the reflected light 64 becomes weak, and thus, the sensor 60 transmits an electrical signal indicating that the surface density of the medium ME0 is high, for example, a low detected voltage, to the controller 10.

As described above, the sensor 60 detects a density of locations X2 on the medium ME0 on which the droplets 37 ejected from the nozzle array 33 in the main scan S0 land while moving along the main scan direction D1 together with the printing head 30. Therefore, the printing head 30 ejects the dark-colored droplets 37 from the nozzle array 33, and the sensor 60 detects the surface density of the medium ME0, so that the controller 10 can detect the landing position X2 in the main scan direction D1 of the droplet 37 ejected from the nozzle array 33 based on a detection result of the sensor 60. The sensor 60 and the controller 10 perform a detection step ST2.

A position of each nozzle array 33 and sensor 60 in the main scan direction D1 can be detected based on a detection signal of the linear encoder 51a illustrated in FIG. 1. The distance ΔX0 from a detection position X0 of the sensor 60 to the position X1 of each nozzle array 33 in the main scan direction D1 is determined in advance. Of course, the distance ΔX0 varies depending on the nozzle array 33, and in the example illustrated in FIG. 2, the distance ΔX0 increases in an order of the black nozzle array 33K, the yellow nozzle array 33Y, the magenta nozzle array 33M, and the cyan nozzle array 33C. Since there is a platen gap AZ between a surface of the platen 58 and the nozzle surface 30a, the carriage 52 moving along the main scan direction D1 moves a distance ΔX1 from the position X1 at which the nozzle array 33 ejects the droplets 37 to the position X2 at which the droplet 37 lands. Since a movement speed of the carriage 52 is set to be the same between the first main scan S1 of the outward route and the second main scan S2 of the return route, the movement distance ΔX1 is the same in the outward route and the return route. Therefore, the movement distance ΔX1 is set as the adjustment value ΔX in the ejection timing adjustment unit 16, so that the ejection timing of the droplet 37 is adjusted in the outward route and the return route.

The printer 2 illustrated in FIG. 3 is capable of performing bidirectional band printing including an overlapping portion OL, for example, causes the droplets 37 to land in a band BC on the medium ME0 in one main scan S0, and feeds the medium ME0 in the feeding direction D3 by a size excluding the overlapping portion OL in the band BC between the main scans S0. For the overlapping portion OL, the droplet 37 lands in two consecutive main scans S0. The plurality of main scans S0 involving the ejection of the droplets 37 alternately include the first main scan S1 of the outward route and the second main scan S2 of the return route. The printed image IM0 is formed in the odd-numbered bands B1, B3, . . . in the plurality of bands BC in the first main scan S1, and the printed image IM0 is formed in the even-numbered bands B2, B4, . . . in the second main scan S2. Therefore, the printer 2 performs bidirectional partial overlap printing for forming the printed image IM0 in units of bands BC including the overlapping portion OL. The controller 10 illustrated in FIG. 1 controls the printing head 30 and the drive unit 50 so that the plurality of main scans S0 involving the ejection of the droplets 37 and sub-scan between the main scans S0 are performed based on the image data, and the droplets 37 are ejected at the timing according to the adjustment value ΔX for determining the position of the printing head 30 at the point in time when the droplets 37 are ejected from the nozzle array 33 in each main scan S0.

The printing head 30 mounted on the carriage 52 illustrated in FIG. 3 first ejects the droplets 37 from the nozzle array 33 onto the band B1 including the overlapping portion OL while moving in the outward direction D11. When the ejection of the droplet 37 onto the band B1 ends, the roller drive unit 55 feeds the medium ME0 in the feeding direction D3 by the size of the band BC excluding the overlapping portion OL. Next, the printing head 30 ejects the droplet 37 from the nozzle array 33 onto the band B2 including the overlapping portion OL while moving in the return direction D12. When the ejection of the droplet 37 onto the band B2 ends, the roller drive unit 55 feeds the medium ME0 in the feeding direction D3 by the size of the band BC excluding the overlapping portion OL. Further, the printing head 30 ejects the droplets 37 from the nozzle array 33 onto the band B3 including the overlapping portion OL while moving in the outward direction D11. When the ejection of the droplet 37 onto the band B3 ends, the roller drive unit 55 feeds the medium ME0 in the feeding direction D3 by the size of the band BC excluding the overlapping portion OL. Further, the printing head 30 ejects the droplets 37 from the nozzle array 33 onto the band B4 including the overlapping portion OL while moving in the return direction D12. When the ejection of the droplet 37 onto the band B4 ends, the roller drive unit 55 feeds the medium ME0 in the feeding direction D3 by the size of the band BC excluding the overlapping portion OL.

As described above, the controller 10 moves the printing head 30 in the outward direction D11 in the first main scan S1, moves the printing head 30 in the return direction D12 in the second main scan S2, and causes the roller drive unit 55 to perform sub-scan between the main scans S0. The printer 2 completes the printed image IM0 in units of bands BC by performing the plurality of main scans S0 involving the ejection of the droplets 37 and the sub-scan between the main scans S0.

When the adjustment value ΔX set in the ejection timing adjustment unit 16 is appropriate, a ruled line LO along the sub-scan direction D2 is not shifted between the bands B0. However, when characteristics of the liquid 36, an environmental temperature, or the like change, an ejection speed of the droplet 37 may change, and the distance ΔX1 from the ejection position X1 to the landing position X2 of the droplet 37 may change. For example, when the printer 2 is not used for a long period of time, such as during holidays, the liquid 36 near the nozzle array 33 thickens due to being dried. When the liquid 36 thickens, the ejection speed of the droplet 37 decreases, and thus, when the printer 2 starts printing after a holiday or the like, the distance ΔX1 from the ejection position X1 to the landing position X2 of the droplet 37 increases. Further, when the liquid 36 contains a pigment, a pigment density of the liquid 36 gradually increases as the printer 2 is used, thereby thickening the liquid 36. When the printer 2 performs printing in this state, the distance ΔX1 from the ejection position X1 to the landing position X2 of the droplet 37 becomes longer, and when the liquid cartridge 35 is replaced, the above-described distance ΔX1 becomes shorter due to the elimination of the thickening. Further, when the printer 2 performs continuous printing, a temperature of the liquid 36 increases due to heat generated by the printer 2, and the viscosity of the liquid 36 decreases. When the viscosity of the liquid 36 decreases, the ejection speed of the droplet 37 increases, and thus, the distance ΔX1 from the ejection position X1 to the landing position X2 of the droplet 37 becomes shorter during continuous printing.

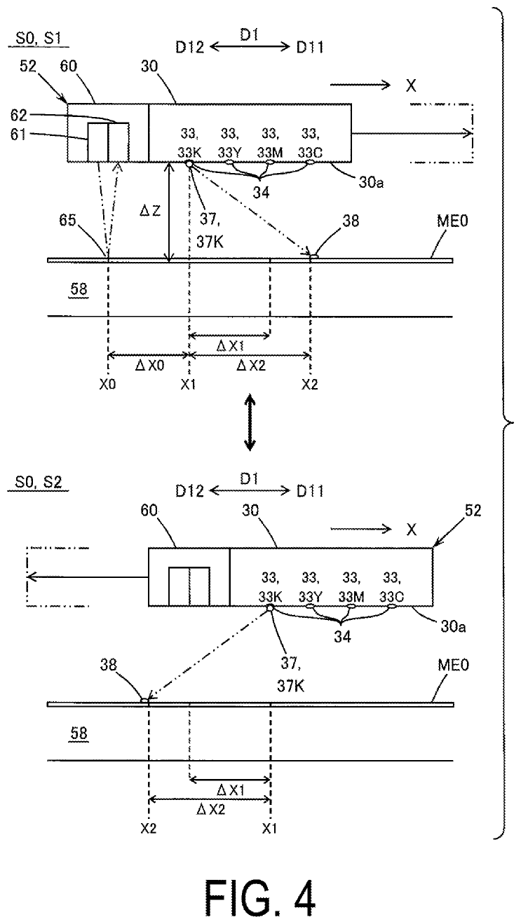

FIG. 4 schematically illustrates the landing position X2 when the ejection speed of the droplet 37 is low.

When the ejection speed of the droplet 37 is low, a distance ΔX2 from the ejection position X1 to the landing position X2 of the droplet 37 is greater than the distance ΔX1 illustrated in FIG. 2. When the adjustment value ΔX is set to the distance ΔX1, the landing position X2 deviates in the outward direction D11 in the first main scan S1 of the outward route, and the landing position X2 deviates in the return direction D12 opposite to the outward direction D11 in the second main scan S2 of the return route. As a result, a position of the ruled line L9 is shifted in the main scan direction D1 between the bands B1 and B3 of the outward route and the bands B2 and B4 of the return route, and the image quality of the printed image IM0 is degraded. Although not illustrated, the distance ΔX2 when the ejection speed of the droplet 37 is high is shorter than the distance ΔX1 illustrated in FIG. 2. When the adjustment value ΔX is set to the distance ΔX1, the landing position X2 is shifted in the return direction D12 in the first main scan S1 of the outward route, and the landing position X2 is shifted in the outward direction D11 in the second main scan S2 of the return route. Accordingly, the positions of the ruled lines are shifted in the main scan direction D1 between the bands B1 and B3 of the outward route and the bands B2 and B4 of the return route, and the image quality of the printed image IM0 is degraded.

From the above, when the adjustment value ΔX is obtained based on the test pattern, it is difficult to curb the deterioration in the image quality of the printed image IM0 due to the change in the droplet landing position X2 according to a state of the printer 2 at the time of printing execution with the adjustment value ΔX alone. Printing the test pattern on the medium ME0 many times in order to respond to change in the droplet landing position X2 requires printing the test pattern many times in addition to a printed matter of an image desired by the user, and work for the user of setting the adjustment value ΔX is also required each time the test pattern is printed.

Therefore, in this specific example, the shift of the landing position X2 can be compensated for during actual printing without printing the test pattern for adjustment, by detecting the landing position X2 during actual printing of the image desired by the user using the sensor 60. The “image desired by the user” means an image such as a line image or a natural image that is not intended to compensate for the deviation of the landing position X2, and does not include the test pattern. Compensating for the deviation of the landing position X2 means reducing the deviation of the landing position X2 as much as possible, and is not limited to reducing the deviation of the landing position X2 to zero.

FIG. 5 schematically illustrates an example in which image data indicating the image desired by the user is used to compensate for the deviation of the landing position X2. In FIG. 5, an example in which K ink amount data DA2k indicating a use amount of the liquid 36 of which color is K in the ink amount data DA2 is used as the above-described image data to compensate for the deviation of the landing position X2 is illustrated. In a lower part of FIG. 5, an example in which an edge detection filter F0 for detecting the edge E0 in a vertical direction included in the feature portion C0 from which the landing position can be detected is applied to the image data is illustrated.

Since the edge E0 intersecting with the main scan direction D1, such as an edge along the sub-scan direction D2 in an image, is a location at which the density of the printed image IM0 changes suddenly in the main scan direction D1, the edge E0 is easy to detect with the sensor 60. Further, an edge of K has a larger change in density than edges of C, M, or Y. Since the K dots 38 have higher visibility than the non-K dots 38, the deviation of the landing position X2 is likely to affect the image quality of the printed image IM0. Composite black, which is a combination of C, M, and Y, easily bleeds because a total amount of the ejected liquid 36 increases, and the deviation of the landing position X2 between the main scans S0 is not noticeable. Further, when an infrared sensor in which the light-emitting unit 61 emits infrared light as the light 63 and the light reception unit 62 detects infrared light as the reflected light 64 is used as the sensor 60, the infrared sensor sensitively detects change in density of K, and has low sensitivity to change in density of C, M, and Y. Therefore, an example in which the edge E0 intersecting with the main scan direction D1 is detected from the K ink amount data DA2k will be described. In this case, the composite black portion in the ink amount data DA2 is not set as the feature portion C0.

The edge E0 intersecting with the main scan direction D1 in the K ink amount data DA2k can be detected by comparing a threshold value with a calculation value obtained by a filter calculation in which the edge detection filter F0 is applied to the K ink amount data DA2k. As the edge detection filter F0 for detecting the edge E0, it is possible to use various known filters such as a Sobel filter F1 or a filter F2 with stronger smoothing, as illustrated in a lower part of FIG. 5.

Here, a variable for identifying a plurality of pixels PX0 matched with the edge detection filter F0 with the pixel of interest PX1 as a center is t, Nf filter coefficients included in the edge detection filter F0 is Kt, and a pixel value of the pixel PX0 matched to the filter coefficient Kt with the pixel of interest PX1 as a center in image data such as the K ink amount data DA2k is Pt. The filter coefficient Kt includes a fraction for normalization. For example, the filter coefficient Kt of the Sobel filter F1 includes a denominator 8 for normalization, and the filter coefficient Kt of the filter F2 includes a denominator 6 for normalization. When the calculation value obtained by the filter calculation is Q, the filter calculation is performed according to the following equation.

$$\begin{matrix}[ Math 1 ] & \\ Q = {\sum }_{t = 1}^{Nf} Kt \times Pt & ( 1 )\end{matrix}$$

When a positive threshold value that is compared with the absolute value of the calculation value Q is Tf, it can be detected that, for example, the pixel of interest PX1 is included in the edge E0 when the absolute value of the calculation value Q exceeds the threshold value Tf, and the pixel of interest PX1 is not included in the edge E0 when the absolute value of the calculation value Q is equal to or smaller than the threshold value Tf. In the first main scan S1 of the outward route, the calculation value Q becomes positive at the edge E0 of the first switching portion SW1 in which the ejection state of the droplet 37 from the black nozzle array 33K moving in the outward direction D11 changes from non-ejection to ejection. In the first main scan S1 of the outward route, the calculation value Q becomes negative at the edge E0 of the second switching portion SW2 in which the ejection state of the droplet 37 from the black nozzle array 33K moving in the outward direction D11 changes from ejection to non-ejection. Further, in the second main scan S2 of the return route, the calculation value Q becomes negative at the edge E0 of the second switching portion SW2 in which the ejection state of the droplet 37 from the black nozzle array 33K moving in the return direction D12 changes from non-ejection to ejection. In the second main scan S2 of the return route, the calculation value Q becomes positive at the edge E0 of the first switching portion SW1 in which the ejection state of the droplet 37 from the black nozzle array 33K moving in the return direction D12 changes from ejection to non-ejection.

FIG. 6 schematically illustrates the feature portion C0 from which the landing position X2 can be detected. In FIG. 6, an example in which the printed image IM0 is formed in the band B1 in the first main scan S1 of the outward route, and the printed image IM0 is formed in the band B2 in the second main scan S2 of the return route which is the next main scan S0 is illustrated.

The printing head 30 illustrated in FIG. 6 includes a plurality of nozzle arrays 33 in which the nozzles 34 of #1 to #400 are aligned at equal intervals in the feeding direction D3. When the partial overlap printing is performed, the #400 side of the nozzle array 33 in the first main scan S1 and the #1 side of the nozzle array 33 in the second main scan S2 overlap by the number of nozzles NOL. In this case, the nozzles 34 from #(401-NOL) to #400 in the first main scan S1 overlap the nozzles 34 from #1 to #4 in the second main scan S2, and the overlapping portion OL is generated in the bands B1 and B2. The number of nozzles NOL is not particularly limited, but may be four when the nozzles 34 are aligned at 600 dpi in the feeding direction D3 in the nozzle array 33 with 400 nozzles.

The controller 10, for example, controls the ejection timing of the droplet 37 so that the position of the feature portion C0 in the band B2 is matched with the position of the feature portion C0 in the band B1 in the main scan direction D1, with respect to the feature portion C0 coupled from the band B1 to the band B2 in the image data. The feature portion C0 illustrated in FIG. 6 is coupled from a portion in which the printed image IM0 is formed in the first main scan S1 (band B1) to a portion in which the printed image IM0 is formed in the second main scan S2 (band B2). In the feature portion C0, locations in which the density is easily detected by the sensor 60 are the edge E0 of the first switching portion SW1 and the edge E0 of the second switching portion SW2. Therefore, the controller 10 controls the ejection timing of the droplet 37 so that the position of the edge E0 in the band B2 is matched with the position of the edge E0 in the band B1 in the main scan direction D1.

For example, it is assumed that the controller 10 detects the landing position X2 at the position of the edge E0 of the first switching portion SW1 in the first main scan S1 together with the sensor 60. In this case, the controller 10 controls the ejection timing of the droplet 37 in the second main scan S2 so that a formation position of the edge E0 of the first switching portion SW1 in the second main scan S2 approaches a formation position of the edge E0 of the first switching portion SW1 in the first main scan S1, based on the detected landing position X2. In other words, the control unit U1 controls the ejection timing of the droplet 37 in the second main scan S2 so that the landing position X2 of the first switching portion SW1 in the second main scan S2 approaches the landing position X2 of the first switching portion SW1 in the first main scan S1, based on the detected landing position X2.

Further, it is assumed that the controller 10 detects the landing position X2 at the position of the edge E0 of the second switching portion SW2 in the first main scan S1 together with the sensor 60. In this case, the controller 10 controls the ejection timing of the droplet 37 in the second main scan S2 so that the formation position of the edge E0 of the second switching portion SW2 in the second main scan S2 approaches the formation position of the edge E0 of the second switching portion SW2 in the first main scan S1, based on the detected landing position X2. In other words, the control unit U1 controls the ejection timing of the droplet 37 in the second main scan S2 so that the landing position X2 of the second switching portion SW2 in the second main scan S2 approaches the landing position X2 of the second switching portion SW2 in the first main scan S1, based on the detected landing position X2.

As illustrated in FIG. 6, the feature portion C0 includes the first feature area A1 and the second feature area A2 in the band B1, and includes the third feature area A3 in the band B2. The first feature area A1 and the second feature area A2 are detection targets of the landing position X2, and the third feature area A3 is a compensation target of the deviation of the landing position X2.

FIG. 7 schematically illustrates the first feature area A1 in which Nx dots are continuous in the return direction D12 from the second switching portion SW2 in the band B1. In FIG. 7, an example in which the K dot data DA3k indicating a formation state of the K dots 38 in the dot data DA3 is used as the above-described image data to extract the detection target of the landing position X2 is illustrated. As described above, when the infrared sensor is used as the sensor 60, the infrared sensor sensitively detects change in density of K, and has low sensitivity to change in density of C, M, and Y. Therefore, an example in which the detection target of the landing position X2 is extracted from the K dot data DA3k will be described.

The first feature area A1 is an area in which the number Nx of droplets 37 larger than the first threshold value TH1, for example, the black droplets 37K illustrated in FIG. 2 or the like land continuously in the return direction D12 from the switching portion SW2 in the first main scan S1 on the surface of the medium ME0. The controller 10 controls the ejection timing of the droplet 37 in the second main scan S2 so that the landing position X2 of the switching portion SW2 in the second main scan S2 approaches the landing position X2 of the switching portion SW2 in the first main scan S1, based on the landing position X2 detected in the first main scan S1 at the position of the switching portion SW2 coupled to the first feature area A1.

The feature portion C0 including the first feature area A1 is extracted for the following reason.

When the droplet 37 is ejected continuously in the main scan direction D1 from the printing head 30 moving along the main scan direction D1, the first ejected droplet 37 is affected by a surrounding airflow, and wind generated by itself serves as a wind shield for the droplet 37 that is ejected later. In the first main scan S1 of the outward route, since the printing head 30 moves in the outward direction D11, an error due to the influence of the surrounding airflow occurs in the landing position X2 at the position of the first switching portion SW1 in which change occurs from non-ejection to ejection. On the other hand, when the number Nx of droplets 37 larger than the first threshold value TH1 from the first switching portion SW1 are continuously ejected from the printing head 30, the first ejected droplet 37 serves as a wind shield so that the ejection characteristics of the subsequent droplets 37 are stabilized. Since the sensor 60 can detect the second switching portion SW2 in which change occurs from ejection to non-ejection, the landing position X2 at the position of the second switching portion SW2 that appears after the number Nx of droplets 37 larger than the first threshold value TH1 are continuously ejected from the printing head 30 has high accuracy. Therefore, the first feature area A1 in which the number Nx of droplets 37 larger than the first threshold value TH1 land on the medium ME0 continuously in the return direction D12 from the second switching portion SW2 in the first main scan S1 is included in the feature portion C0.

The first threshold value TH1 is not particularly limited, but may be three when the resolution in the main scan direction D1 is 600 dpi. In this case, the first feature area A1 becomes an area in which four or more droplets 37 land on the medium ME0 continuously in the return direction D12 from the second switching portion SW2.

Since the feature portion C0 includes the first feature area A1, the switching portion SW2 in which the number Nx of droplets 37 larger than the first threshold value TH1 are not ejected after the droplets 37 are ejected from the nozzle array 33 appears in the first feature area A1 in the first main scan S1, and the detection accuracy of the landing position X2 is improved. Therefore, deterioration in the image quality of the printed image IM0 due to change in the landing position X2 of the droplet 37 during the use of the printing device 1 is curbed.

FIG. 8 schematically illustrates the second feature area A2 in which the switching portions SW1 and SW2 are continuous for NY1 dots in the feeding direction D3 in the band B1. In FIG. 8, an example in which the K dot data DA3k is used as the above-described image data to extract the detection target of the landing position X2 is also illustrated.

The second feature area A2 is an area in which a number of droplets 37 larger than the second threshold value TH2, for example, the black droplets 37K illustrated in FIG. 2 and the like land continuously in the feeding direction D3 in the switching portions SW1 and SW2 formed in the first main scan S1 on the surface of the medium ME0. The controller 10 controls the ejection timing of the droplet 37 in the second main scan S2 so that the landing position X2 of the second feature area A2 in the second main scan S2 approaches the landing position X2 of the second feature area A2 in the first main scan S1, based on the landing position X2 detected in the first main scan S1 at the position of the second feature area A2.

The reason for extraction of the feature portion C0 including the second feature area A2 is as follows.

The droplets 37 ejected from both end portions in the feeding direction D3 of the printing head 30 moving along the main scan direction D1, for example, from the #1 and #400 nozzles 34 are affected by a surrounding airflow. On the other hand, the droplets 37 ejected from portions of the printing head 30 on the inner side of both end portions described above, for example, the #200 and #201 nozzles 34 are less likely to be affected by the surrounding airflow. Therefore, the ejection characteristics of the droplet 37 from the above-described portion on the inner side in the printing head 30 are stabilized. Therefore, the second feature area A2 in which a number of droplets 37 larger than the second threshold value TH2 land on the medium ME0 continuously in the feeding direction D3 in the switching portions SW1 and SW2 formed in the first main scan S1 is included in the feature portion C0.

The second threshold value TH2 is not particularly limited, but may be 10 when the nozzles 34 in the nozzle array 33 with 400 nozzles are aligned at 600 dpi in the feeding direction D3 as illustrated in FIG. 6. In this case, the second feature area A2 is an area in which eleven or more droplets 37 land on the medium ME0 continuously in the feeding direction D3 in the switching portions SW1 and SW2 formed in the first main scan S1.

The detection range 65 of the sensor 60 illustrated in FIG. 6 is at a portion on the inner side of both end portions in the feeding direction D3 of the printing head 30, for example, a portion inside the nozzle array 33 excluding the number of nozzles 34 corresponding to the second threshold value TH2 from both end portions. The detection range 65 may be a portion close to the upstream end that is toward the sub-scan direction D2 in the above-described portion on the inner side. When the second threshold value TH2 is 10 in the nozzle array 33 with 400 nozzles, the detection range 65 is in a range of the nozzles 34 with #11 to #390, and may be a range including the nozzle 34 with #390 and closer to #390 than #11, instead of including the nozzles 34 with #1 to #10 as much as possible.

Since the feature portion C0 includes the second feature area A2, the droplet 37 ejected from the above-described portion on the inner side of the printing head 30 lands in the second feature area A2 in the first main scan S1, and thus, the detection accuracy of the landing position X2 is improved. Therefore, deterioration in the image quality of the printed image IM0 due to change in the landing position X2 of the droplet 37 during the use of the printing device 1 is curbed.

FIG. 9 schematically illustrates the third feature area A3 in which the switching portions SW1 and SW2 continuous from the band B1 to the band B2 are continuous for NY2 dots in the feeding direction D3 in the band B2. In FIG. 9, an example in which the K dot data DA3k is used as the above-described image data to extract a correction target of the landing position X2 is illustrated.

The third feature area A3 is an area in which a number of droplets 37 larger than the third threshold value TH3 land continuously in the feeding direction D3 in a portion of the surface of the medium ME0 that is formed in the second main scan S2 in the switching portions SW1 and SW2 formed between the first main scan S1 and the second main scan S2. The controller 10 controls the ejection timing of the droplet 37 in the second main scan S2 so that the landing position X2 of the switching portions SW1 and SW2 in the second main scan S2 approaches the landing position X2 of the switching portions SW1 and SW2 in the first main scan S1, based on the landing position X2 detected in the first main scan S1 at the position of the third feature area A3.

When the correction target of the landing position X2 is short in the feeding direction D3, the deviation of the landing position X2 between the main scans S0 is not noticeable, and when the correction target of the landing position X2 is long in the feeding direction D3, the deviation of the landing position X2 between the main scans S0 is noticeable. In particular, when the feature portion C0 falls within the overlapping portion OL in the second main scan S2, the deviation of the landing position X2 between the main scans S0 is not noticeable, and when the feature portion C0 is longer than the overlapping portion OL in the second main scan S2, the deviation of the landing position X2 between the main scans S0 is noticeable. Therefore, the third feature area A3 in which the number of ink droplets larger than the third threshold value TH3 land continuously in the feeding direction D3 in the portion that is formed in the second main scan S2 in the switching portions SW1 and SW2 is included in the feature portion C0.

The third threshold value TH3 is not particularly limited, but may be around the number of nozzles NOL in the overlapping portion OL, for example, NOL−1. When NOL is four, TH3 is three. In this case, the third feature area A3 is an area in which four or more droplets 37 land on the medium ME0 continuously in the feeding direction D3 in the portion that is formed in the second main scan S2 in the switching portions SW1 and SW2.

When the feature portion C0 includes the third feature area A3, the landing position X2 of the switching portions SW1 and SW2 in the second main scan S2 approaches the landing position X2 of the switching portions SW1 and SW2 in the first main scan S1. Therefore, deterioration in the image quality of the printed image IM0 due to change in the landing position X2 of the droplet 37 during the use of the printing device 1 is curbed.

FIG. 10 schematically illustrates a case in which a dark-colored portion including the switching portions SW1 and SW2 is set as the feature portion C0. A plurality of the above-described feature portions C0 may appear in the combination of the bands B1 and B2, in other words, in the combination of the first main scan S1 and the second main scan S2, as illustrated in FIG. 10.

The image data illustrated in FIG. 10, for example, the K ink amount data DA2k includes the letter LE1 and ruled lines L11 to L16.

Even when the letter LE1 has a dark color, the deviation of the landing position X2 between the main scans S0 is not noticeable. Therefore, when the switching portions SW1 and SW2 are present in the range of the letter LE1 represented by the letter range information, the controller 10 does not set the switching portions SW1 and SW2 as the letter LE1 to the feature portion C0, and excludes the switching portions SW1 and SW2 from a target of compensation of the deviation of the landing position X2. This makes it possible to improve the image quality of the printed image IM0 more easily than when the letter LE1 is a target.

The ruled lines L11, L13, and L15 indicate that the feature portion C0 including the first feature area A1, the second feature area A2, and the third feature area A3 is extracted as illustrated in a lower part of FIG. 10, from the K ink amount data DA2k and the K dot data DA3k. Therefore, the controller 10 controls the ejection timing of the droplet 37, for example, so that the landing position X2 of the second switching portion SW2 in the second main scan S2 approaches the landing position X2 of the second switching portion SW2 in the first main scan S1.

The ruled line L12 is a portion in which the number Nx (see FIGS. 6 and 7) of droplets 37 continuous in the return direction D12 from the second switching portion SW2 in the band B1 is determined to be equal to or smaller than the first threshold value TH1 from the K ink amount data DA2k and the K dot data DA3k. Therefore, the controller 10 discriminates that the first feature area A1 is not present in the ruled line L12, and does not set the ruled line L12 as the feature portion C0. In the example illustrated in FIG. 10, the ruled line L12 is not extracted as the feature portion C0 even when the second feature area A2 or the third feature area A3 is present in the ruled line L12, but when at least one of the second feature area A2 or the third feature area A3 is present in the ruled line L12, the ruled line L12 may be extracted as the feature portion C0.

The ruled line L14 is a portion in which the number NY1 (see FIGS. 6 and 8) of continuous droplets 37 in the switching portions SW1 and SW2 in the feeding direction D3 in the band B1 is determined to be equal to or smaller than the second threshold value TH2 from the K ink amount data DA2k and the K dot data DA3k. Therefore, the controller 10 discriminates that the second feature area A2 is not present in the ruled line L14, and does not set the ruled line L14 as the feature portion C0. In the example illustrated in FIG. 10, the ruled line L14 is not extracted as the feature portion C0 even when the first feature area A1 or the third feature area A3 is present in the ruled line L14, but when at least one of the first feature area A1 or the third feature area A3 is present in the ruled line L14, the ruled line L14 may be extracted as the feature portion C0.

The ruled line L16 is a portion in which the number NY2 (see FIGS. 6 and 9) of continuous droplets 37 in the switching portions SW1 and SW2 in the feeding direction D3 band B2 is determined to be equal to or smaller than the third threshold value TH3 from the K ink amount data DA2k and the K dot data DA3k. Therefore, the controller 10 discriminates that the third feature area A3 is not present in the ruled line L16, and does not set the ruled line L16 as the feature portion C0. In the example illustrated in FIG. 10, the ruled line L16 is not extracted as the feature portion C0 even when the first feature area A1 or the second feature area A2 is present in the ruled line L16, but when at least one of the first feature area A1 or the second feature area A2 is present in the ruled line L16, the ruled line L16 may be extracted as the feature portion C0.

When a plurality of feature portions C0 appear in a combination of the first main scan S1 and the second main scan S2, the distance ΔX1 (see FIG. 2) from the ejection position X1 to the landing position X2 of the droplet 37 may be different depending on the feature portion C0. This is due to a slight variation in the ejection characteristics of each nozzle 34, a slight variation in the platen gap AZ (see FIG. 2) due to slight inclination of, for example, the printing head 30, or a variation in the above-described distance ΔX1 due to an undulation of the medium ME0 such as cockling, or the like.

When the controller 10 uniformly adjusts the ejection timing of the droplet 37 in the entire second main scan S2, the controller 10 may adjust the ejection timing of the droplet 37, aiming at an average value of the distance ΔX1 corresponding to the landing position X2 detected at the position of each feature portion C0. For example, as illustrated in the lower part of FIG. 10, when distances from the ejection position X1 to the landing position X2 in the second switching portion SW2 of the ruled lines L11, L13, and L15 are ΔX11, ΔX12, and ΔX13, respectively, the controller 10 may use an arithmetic mean value (ΔX11+ΔX12+ΔX13)/3 of the distances as the adjustment value ΔX illustrated in FIG. 1.

When the ejection timing of the droplet 37 in the entire second main scan S2 is uniformly adjusted, the landing position X2 of the droplet 37 in the entire band B2 is uniformly controlled according to the adjustment value ΔX that does not change. As a result, in the switching portions SW1 and SW2 following band B1 in the band B2, a formation position on the medium ME0 is adjusted according to the uniform adjustment value ΔX in the main scan direction D1, regardless of whether the switching portions SW1 and SW2 are included in the extracted feature portion C0. For example, even when the number NY2 of dots corresponding to the length within the band B2 (see FIGS. 6 and 9) is as small as the third threshold value TH3 or less as in the case of the ruled line L16, and the number NY2 of dots is larger than the third threshold value TH3 as in the case of the ruled line L11, the position of the ruled line of the band B2 is adjusted according to the uniform adjustment value ΔX in the main scan direction D1. When the feature portion C0 does not appear in the combination of the first main scan S1 and the second main scan S2, the adjustment value of the band B2 remains as the adjustment value ΔX applied to the band B1, and correction of the ejection timing is not performed between the band B1 and the band B2.

The ejection timing can be adjusted for each feature portion C0 by dividing the band B2 into a plurality of parts in the main scan direction D1. For example, as illustrated in the lower part of FIG. 10, the controller 10 may divide the band B2 to a divided area B21 including the ruled line L11, a divided area B22 including the ruled line L13, and a divided area B23 including the ruled line L15 in the main scan direction D1. In the main scan direction D1, a boundary between the divided area B21 and the divided area B22 may be halfway between the ruled line L11 and the ruled line L13, and a boundary between the divided area B22 and the divided area B23 may be halfway between the ruled line L13 and the ruled line L15.

When the ejection timing of the droplet 37 is adjusted for each divided area, the landing position X2 of the droplet 37 in the entire divided area is uniformly controlled according to the adjustment value that does not change for each divided area. The adjustment value may change when the divided area that is a target of formation of the printed image IM0 changes, and when the adjustment value changes, the ejection timing of the droplet 37 changes between the divided areas.

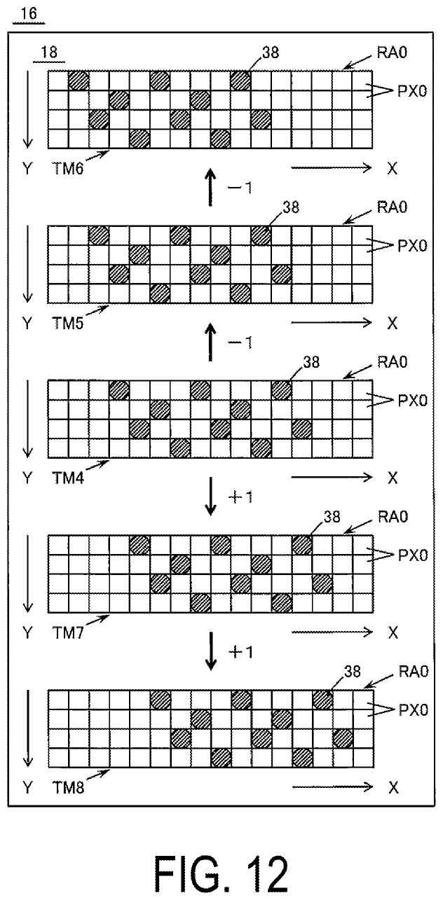

FIGS. 11 and 12 schematically illustrate an example in which the ejection timing of the droplet 37 is changed during the second main scan S2. FIG. 11 schematically illustrates an example in which the ejection timing of the droplet 37 is controlled according to timing change of a drive pulse P0 included in the drive signal SG1 illustrated in FIG. 1. The timing change of the drive pulse P0 is performed by the drive pulse timing adjustment unit 17 included in the ejection timing adjustment unit 16 illustrated in FIG. 1. In an upper part of FIG. 11, the drive pulse P0 at a timing TM2 that is Δt1 earlier than the reference timing TM1 is illustrated, and in a lower part of FIG. 11, the drive pulse P0 at a timing TM3 which is later by Δt1 from the reference timing TM1 is illustrated. In each timing chart, a horizontal axis indicates time t, and a vertical axis indicates an applied voltage E.

A waveform of the drive pulse P0 is just an example and is not limited to a waveform in which the applied voltage E temporarily decreases and then rapidly increases, and may be, for example, a waveform in which the applied voltage E temporarily increases once and then rapidly decreases depending on the drive circuit 31. Furthermore, the number of drive pulses P0 included in one pixel is not limited to one as illustrated in FIG. 11, but may be two or more.

A timing of each drive pulse P0 can be changed within the range of the pixel PX0. For example, since the timing TM2 causes the droplets 37 to be ejected Δt1 earlier than the reference timing TM1, the landing position X2 of the droplet 37 in the second main scan S2 of the return route can be shifted in the outward direction D11. Since the timing TM3 causes the droplets 37 to be ejected Δt1 later than the reference timing TM1, it is possible to shift the landing position X2 of the droplet 37 in the return direction D12 in the second main scan S2 of the return route.

Although not illustrated, the ejection timing adjustment unit 16 may shift the landing position X2 of the droplet 37 by changing a shape of the drive pulse P0 itself and changing the ejection speed of the droplet 37. Of course, the ejection timing adjustment unit 16 may shift the landing position X2 of the droplet 37 through a combination of the timing change of the drive pulse P0 and shape change.

FIG. 12 schematically illustrates an example in which the landing position X2 of the droplet 37 deviates beyond the range of the pixel PX0. The timing change of the drive pulse P0 that exceeds the range of the pixel PX0 is performed by a pixel shifting unit 18 included in the ejection timing adjustment unit 16 illustrated in FIG. 1. In FIG. 12, raster data RAO at a reference timing TM4 and raster data RAO of which timing is changed in units of pixels from the reference timing TM4 are illustrated. In FIG. 12, a timing TM5 is one pixel later than the reference timing TM4, a timing TM6 is two pixels later than the reference timing TM4, a timing TM7 is one pixel earlier than the reference timing TM4, and a timing TM8 is two pixels earlier than the reference timing TM4. In each raster data RAO illustrated in FIG. 12, a horizontal direction is an X direction corresponding to the outward direction D11, and a vertical direction is a Y direction corresponding to the sub-scan direction D2.

In the above case, the timings TM5 and TM6 can shift the landing position X2 of the droplet 37 in the return direction D12 by one pixel and two pixels in the second main scan S2 of the return route, as compared to the reference timing TM4. The timings TM7 and TM8 can shift the landing position X2 of the droplet 37 in the outward direction D11 by one pixel and two pixels in the second main scan S2 of the return route, as compared to the reference timing TM4.

Further, the ejection timing adjustment unit 16 may combine the timing change of the drive pulse P0 as illustrated in FIG. 11 with timing change in units of pixel as illustrated in FIG. 12. In this case, it becomes possible to perform finer timing adjustment than in pixel units beyond the range of the pixel PX0.

The controller 10 can independently adjust the ejection timing of the droplet 37 for each of the divided areas B21 to B23 included in the band B2 by using at least one of the drive pulse timing adjustment unit 17 or the pixel shifting unit 18. Although the ejection timing of the droplet 37 changes between the divided areas, for example, between the divided area B21 and the divided area B22 or between the divided area B22 and the divided area B23, the deviation of the landing position X2 between the main scans S0 is not noticeable, and thus, the image quality of the printed image IM0 is maintained.

### (3) Specific Example of Printing Control Processing Including Adjustment of Droplet Ejection Timing

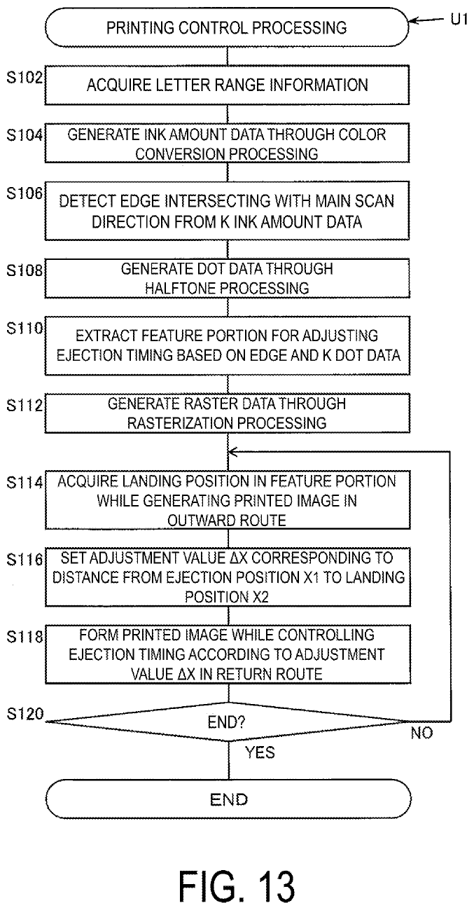

FIG. 13 schematically illustrates the printing control processing including adjustment of the ejection timing of the droplet 37. The printing control processing of steps S102 to S120 illustrated in FIG. 13 is performed by the controller 10 as the control unit U1 illustrated in FIG. 1. Hereinafter, description of “step” may be omitted and a step sign may be shown in parentheses. The sensor 60 illustrated in FIGS. 1, 2, or the like is assumed to be the infrared sensor that has low sensitivity to change in the density of C, M, and Y, but sensitively detects changes in the density of K. It is assumed that the controller 10 controls the ejection timing of the droplet 37 in the second main scan S2 so that the deviation of the landing position X2 of the black droplet 37K between the main scans S0 is compensated for.

For example, when the communication I/F 22 receives the original image data DA1 from the host device HO1, the controller 10 starts the printing control processing.

When the printing control processing starts and the letter LE1 (see FIG. 10) is included in the original image data DA1, the controller 10 acquires the letter range information indicating the range of the letter LE1 from the original image data DA1 (S102).

Next, the controller 10 performs color conversion processing for converting the original image data DA1 into the ink amount data DA2 in the color conversion unit 12 (S104). When the original image data DA1 is RGB data and the ink amount data DA2 is CMYK data having pixel values of, for example, 256 gradations of C, M, Y, and K, the controller 10 performs known color conversion processing for converting the RGB data into CMYK data. In this case, the ink amount data DA2 represents the use amount of C, M, Y, and K liquids 36 in units of pixels PX0 (see FIG. 5), and includes ink amount data for C, ink amount data for M, ink amount data for Y, and the K ink amount data DA2k.

Next, the controller 10 detects the edge E0 intersecting with the main scan direction D1 from the K ink amount data DA2k by applying the edge detection filter F0 as illustrated in FIG. 5 to the K ink amount data DA2k (S106). When the first feature area A1 as illustrated in FIGS. 6 and 7 is included in the feature portion C0, the controller 10 may need only to detect the edge E0 of the second switching portion SW2 in which an ejection state of the black droplet 37K changes from ejection to non-ejection in the first main scan S1 of the outward route and changes from non-ejection to ejection in the second main scan S2 of the return route. Further, the controller 10 may detect the edge E0 of the first switching portion SW1.

Next, the controller 10 performs, in the halftone processing unit 13, known halftone processing for converting the ink amount data DA2 into the dot data DA3 for each color, for example, C, M, Y, and K (S108). The K ink amount data DA2k indicating the use amount of the K liquid 36 is converted into K dot data DA3k indicating the formation state of the K dots 38.

Next, the controller 10 extracts a feature portion C0 for adjusting the ejection timing based on the edge E0 and the K dot data DA3k (S110). As illustrated in FIG. 10, the controller 10 may extract the feature portion C0 including the first feature area A1, the second feature area A2, and the third feature area A3. The first feature area A1 extracted from the K dot data DA3k is an area in which a number Nx of the black droplets 37K larger than the first threshold value TH1 land on the medium ME0 continuously in the return direction D12 from the second switching portion SW2 in the first main scan S1. The second feature area A2 extracted from the K dot data DA3k is an area in which a number of black droplets 37K larger than the second threshold value TH2 land on the medium ME0 continuously in the feeding direction D3 in the switching portions SW1 and SW2 formed in the first main scan S1. The third feature area A3 extracted from the K dot data DA3k is an area in which a number of black droplets 37K larger than the third threshold value TH3 land on the medium ME0 continuously in the feeding direction D3 in a portion that is formed in the second main scan S2 in the switching portions SW1 and SW2 formed between the first main scan S1 and the second main scan S2. When the controller 10 acquires the letter range information in S102, the controller 10 may not set the letter LE1 as the feature portion C0 based on the letter range information.

Further, the controller 10 may extract the feature portion C0 that does not include some of the first feature area A1, the second feature area A2, and the third feature area A3.

Next, the controller 10 generates, in the rasterization processing unit 14, the raster data RAO by performing rasterization processing in which the dot data DA3 is rearranged in an order in which the dots 38 are formed by the drive unit 50 (S112).

After the rasterization processing, the controller 10 causes the printing head 30 to eject the droplets 37 at a timing according to the raster data RAO in the first main scan S1 of the outward route, and acquires the landing position X2 (see FIG. 2) of the black droplets 37K at the position of the feature portion C0 based on the detection result of the sensor 60 (S114). The printed image IM0 is formed in the band B0 corresponding to the first main scan S1 due to the ejection of the droplet 37. When a plurality of feature portions C0 are extracted as illustrated in FIG. 10, the landing position X2 of the black droplet 37K at a position of each feature portion C0 is acquired. When the feature portion C0 is not present in the portion in which the printed image IM0 is formed in the first main scan S1, the landing position X2 is not acquired.

Next, the controller 10 obtains the distance ΔX1 from the ejection position X1 to the landing position X2 for the feature portion C0, and sets the adjustment value ΔX corresponding to the distance ΔX1, in the ejection timing adjustment unit 16 (S116). When a plurality of distances, for example, distances ΔX11 to ΔX13 are obtained as illustrated in FIG. 10, the controller 10 may set an average value of the distances ΔX11 to ΔX13 as the adjustment value ΔX, or may set the adjustment value ΔX in each of the divided areas B21 to B23. When the adjustment value ΔX is set in each of the divided areas B21 to B23, the controller 10 may set the distances ΔX11, ΔX12, and ΔX13 as the adjustment value ΔX in the divided areas B21, B22, and B23, respectively. When the feature portion C0 is not present in the portion in which the printed image IM0 is formed in the first main scan S1, the adjustment value ΔX is not changed.

Next, the controller 10 causes the printing head 30 to eject the droplet 37 at the timing according to the raster data RAO while performing control into the timing according to the adjustment value ΔX in the second main scan S2 of the return route in the ejection timing adjustment unit 16 (S118). Accordingly, the landing position X2 in the second main scan S2 approaches the landing position X2 in the first main scan S1 for the feature portion C0, and the printed image IM0 is formed on the band B0 corresponding to the second main scan S2 due to the ejection of the droplet 37. When the adjustment value ΔX is set for each of the divided areas B21 to B23, the ejection timing of the droplets 37 is controlled for each divided area. In this case, for each feature portion C0, the landing position X2 in the second main scan S2 approaches the landing position X2 in the first main scan S1.

As described above, the controller 10 controls the timing at which the printing head 30 is caused to eject the droplets 37 in the second main scan S2 so that the deviation of the landing position X2 in the main scan direction D1 of the black droplet 37K ejected from the nozzle array 33 between the first main scan S1 and the second main scan S2 is reduced, based on the landing position X2 in the main scan direction D1 of the black droplet 37K detected by the detection unit U2 at the position of the feature portion C0 in the first main scan S1.

The controller 10 repeats the processing of S114 to S118 until the formation of the printed image IM0 is completed (S120). When the formation of the printed image IM0 is completed, the controller 10 ends the printing control processing illustrated in FIG. 13.

As described above, the deviation of the landing position X2 of the droplet 37 ejected from the nozzle array 33 in the main scan direction D1 between the first main scan S1 and the second main scan S2 for forming one printed image IM0 is reduced. Therefore, deterioration in the image quality of the printed image IM0 due to change in the landing position X2 of the droplet 37 during the use of the printing device 1 is curbed.

### (4) Modification Example

Various modification examples of the present disclosure can be considered.

For example, the drive unit 50 may move the printing head 30 instead of moving the medium ME0 along the feeding direction D3, or may move both the medium ME0 and the printing head 30.

Types of color materials that form the printed image IM0 on the medium ME0 are not limited to C, M, Y, and K, and may include orange, green, light cyan with a density lower than C, light magenta with a lower density than M, dark yellow with a higher density than Y, light black with a lower density than K, uncolored coloring material for image quality improvement, and the like, in addition to C, M, Y, and K. Further, the present technology can be applied even when color materials of some of C, M, Y, and K are not used.

The edge E0 in the vertical direction included in the feature portion C0 from which the landing position can be detected is not limited to the K edge, and may be a C or M edge, for example. In this case, the sensor 60 may be a sensor capable of detecting the density of chromatic colors such as R, G, and B. The controller 10 may reduce the deviation of the landing position between the main scans S0 based on the landing position of the droplet 37 other than the black droplet 37K, such as the C or M droplet.

The entity that performs the above-described processing is not limited to the CPU, and may be an electronic component other than the CPU, such as an ASIC. Of course, a plurality of CPUs may cooperate to perform the above-described processing, or a CPU and another electronic component (for example, an ASIC) may cooperate to perform the above-described processing.

The above-described processing can be changed appropriately, such as change in an order. For example, in the printing control processing illustrated in FIG. 13, letter range information acquisition processing in S102 can be performed after the processing of any one of S104, S106, or S108, as long as it is before the feature extraction processing in S110. Part of the above-described processing may be performed by the host device HO1. In this case, the combination of the controller 10 and the host device HO1 is an example of the printing device 1.

The formation of the printed image IM0 is not limited to the above-described partial overlap printing, but may be pseudo band printing in which a main scan for each band is performed twice or more, interlaced printing in which rasters are spaced apart and then a space between rasters is filled in a subsequent main scan, or the like.

The second main scan S2 after the first main scan S1 is not limited to the main scan subsequent to the first main scan S1, but may be a main scan after the main scan involving the ejection of the droplets 37 from the first main scan S1. in this case, since the deviation of the landing position X2 between the first main scan S1 and the second main scan S2 is also reduced, deterioration in the image quality of the printed image IM0 due to change in the landing position X2 of the droplet 37 during the use of the printing device 1 is curbed.

The first main scan S1 may be performed on the return route instead of the outward route, and the second main scan S2 may be performed on the outward route instead of the return route.

Further, the formation of the printed image IM0 is not limited to the bidirectional printing, but unidirectional printing may be used.

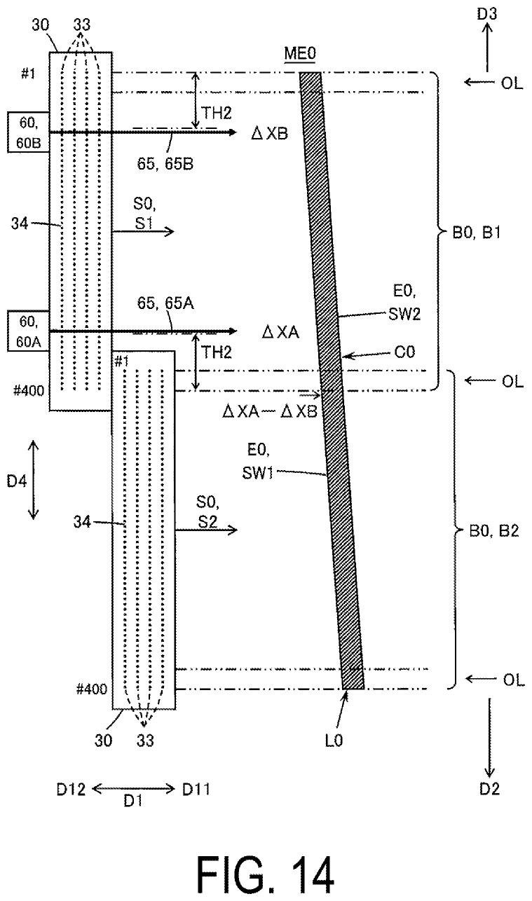

FIG. 14 schematically illustrates a feature portion C0 from which the landing position X2 (see FIG. 2) can be detected in unidirectional printing. In the example illustrated in FIG. 14, both the first main scan S1 and the second main scan S2 are the main scan S0 of the outward route. The ruled line LO serving as the feature portion C0 illustrated in FIG. 14 indicates that the landing position of the droplet 37 on the #400 side in the nozzle array 33, that is, on the upstream in the feeding direction D3 is shifted in the outward direction D11 relative to the landing position of the droplet 37 on the #1 side, that is, on the downstream, for example, due to the inclination of the printing head 30. In FIG. 14, the deviation of the ruled line LO is exaggerated for clarity.

For example, when the platen gap on the #400 side is slightly greater than the platen gap on the #1 side in the nozzle array 33, the distance from the ejection position X1 to the landing position X2 is greater at the #400 nozzle 34 than the #1 nozzle 34. Therefore, the sensor 60 illustrated in FIG. 14 includes an upstream sensor 60A that detects a density of an upstream detection range 65A closer to #400 than #1 in the nozzle array 33, and a downstream sensor 60B that detects a density of a downstream detection range 65B closer to #1 than #400 in the nozzle array 33. The upstream detection range 65A illustrated in FIG. 14 is at a portion close to an upstream end portion in the portion inside the nozzle array 33 excluding the number of nozzles 34 corresponding to the second threshold value TH2 from both end portions. The upstream detection range 65A may be a range including #(400−TH1) nozzles 34 instead of including #(400−TH1+1) to #400 nozzles 34 as much as possible. The downstream detection range 65B illustrated in FIG. 14 is at a portion close to a downstream end portion in the portion inside the nozzle array 33 excluding the number of nozzles 34 corresponding to the second threshold value TH2 from both end portions. The downstream detection range 65B may be a range including #(TH1+1) nozzles 34, instead of including #1 to #TH2 nozzles 34 as much as possible.

As illustrated in FIG. 14, a distance from the ejection position X1 to the landing position X2 based on a detection result of the upstream sensor 60A is ΔXA, and a distance from the ejection position X1 to the landing position X2 based on a detection result of the downstream sensor 60B is ΔXB. In the example illustrated in FIG. 14, the distance ΔXA is larger than the distance ΔXB. Therefore, when the deviation of the landing position X2 between the first main scan S1 and the second main scan S2 is not compensated for, a deviation occurs in the landing position X2 in the main scan direction D1 between an upstream end portion of the band B1 and a downstream end portion of the band B2 in the ruled line LO. When the upstream detection range 65A is sufficiently close to position #400 and the downstream detection range 65B is sufficiently close to #1, the above-described deviation is approximately ΔXA−ΔXB. Therefore, the controller 10 may shift the timing at which the droplets 37 are ejected from the printing head 30 in the second main scan S2 by a distance based on (ΔXA−ΔXB) from the first main scan S1. In the example illustrated in FIG. 14, the controller 10 delays the ejection timing of the droplet 37 by a distance based on (ΔXA−ΔXB) in the second main scan S2.

As described above, the controller 10 reduces the deviation of the landing position X2 of the droplet 37 in the first main scan S1 of the outward route and the second main scan S2 of the outward route, based on the landing position detected in the first main scan S1. Therefore, deterioration in the image quality of the printed image IM0 due to change in the landing position X2 of the droplet 37 during the use of the printing device 1 is curbed.

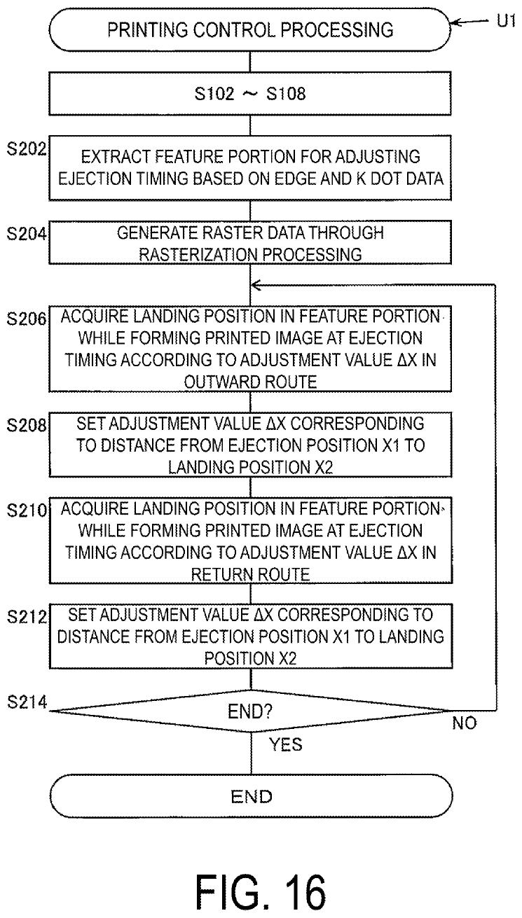

Further, as illustrated in FIGS. 15 and 16, in bidirectional printing, the controller 10 may perform control so that the landing position X2 of the return route approaches the landing position X2 of the outward route, and also the landing position X2 of the outward route approaches the landing position X2 of the return route. FIG. 15 schematically illustrates the landing position X2 of the droplet 37 ejected from the nozzle array 33 at the time of the main scan in the printing device 1 including the sensors 60 on both sides of the printing head 30. A state of the first main scan S1 of the outward route is illustrated on upper side of FIG. 15, and a state of the second main scan S2 of the return route is illustrated on the lower side of FIG. 15. FIG. 16 schematically illustrates printing control processing in the printing device 1 that includes sensors 60 on both sides of the printing head 30. Since the processing from S102 to S108 illustrated in FIG. 16 is the same as the processing from S102 to S108 illustrated in FIG. 13, the processing is illustrated in a simplified manner.

The sensor 60 illustrated in FIG. 15 includes the first direction side sensor 601 at a position toward the outward direction D11 from the printing head 30, and the second direction side sensor 602 at a position toward the return direction D12 from the printing head 30. The first direction side sensor 601 and the second direction side sensor 602 are mounted on the carriage 52 together with the printing head 30, and each include the light-emitting unit 61 and the light reception unit 62. The second direction side sensor 602 detects a density of locations on which the droplets 37 ejected from the nozzle array 33 land on the surface of the medium ME0 while moving in the outward direction D11 together with the printing head 30 in the first main scan S1 of the return route. The first direction side sensor 601 detects a density of locations on which the droplets 37 ejected from the nozzle array 33 land on the surface of the medium ME0 while moving in the return direction D12 together with the printing head 30 in the second main scan S2 of the return route.

When the printing control processing starts and the letter LE1 (see FIG. 10) is included in the original image data DA1, the controller 10 acquires the letter range information, performs the color conversion processing, detects the edge E0 intersecting with the main scan direction D1, and performs the halftone processing (S102 to S108). Next, the controller 10 extracts the feature portion C0 for adjusting the ejection timing based on the edge E0 and the K dot data DA3k (S202). Here, when the first main scan S1 in the outward route is performed, the first feature area A1 included in the feature portion C0 may be an area in which a number Nx of the black droplets 37K larger than the first threshold value TH1 land continuously in the return direction D12 from the second switching portion SW2, as illustrated in FIGS. 6 and 7. When the second main scan S2 of the return route is performed, the first feature area A1 is an area in which the number Nx of the black droplets 37K larger than the first threshold value TH1 land continuously in the outward direction D11 from the first switching portion SW1.

Next, the controller 10 generates raster data RAO by performing the rasterization processing in the rasterization processing unit 14 (S204).

After the rasterization processing, the controller 10 causes the printing head 30 to eject the droplet 37 at the timing according to the raster data RAO while performing control into a timing according to the adjustment value ΔX in the first main scan S1 of the outward route in the ejection timing adjustment unit 16 (S206). The printed image IM0 is formed on the band BC corresponding to the first main scan S1 due to the ejection of the droplet 37. When the adjustment value ΔX is set for each divided area, the controller 10 controls the ejection timing of the droplet 37 according to the adjustment value ΔX for each divided area. Further, the controller 10 acquires the landing position X2 of the black droplet 37K at the position of the feature portion C0 based on the detection result of the second direction side sensor 602. When the plurality of feature portions C0 are extracted, the landing position X2 of the black droplet 37K at the position of each feature portion C0 is acquired. When the feature portion C0 is not present in the portion in which the printed image IM0 is formed in the first main scan S1, the landing position X2 is not acquired.

Next, the controller 10 obtains the distance ΔX1 from the ejection position X1 to the landing position X2 for the feature portion C0, and sets the adjustment value ΔX corresponding to the distance ΔX1, in the ejection timing adjustment unit 16 (S208). When a plurality of distances are determined, the controller 10 may set an average value of the plurality of distances as the adjustment value ΔX, or may set the adjustment value ΔX for each divided area. When the feature portion C0 is not present in the portion in which the printed image IM0 is formed in the first main scan S1, the adjustment value ΔX is not changed.

Next, the controller 10 causes the printing head 30 to eject the droplet 37 at the timing according to the raster data RAO while performing control into the timing according to the adjustment value ΔX in the second main scan S2 of the return route in the ejection timing adjustment unit 16 (S210). Accordingly, the landing position X2 in the second main scan S2 approaches the landing position X2 in the first main scan S1 for the feature portion C0, and the printed image IM0 is formed on the band B0 corresponding to the second main scan S2 due to the ejection of the droplet 37. When the adjustment value ΔX is set for each divided area, the controller 10 controls the ejection timing of the droplet 37 according to the adjustment value ΔX for each divided area. In this case, for each feature portion C0, the landing position X2 in the second main scan S2 approaches the landing position X2 in the first main scan S1. Further, the controller 10 acquires the landing position X2 of the black droplet 37K at the position of the feature portion C0 based on the detection result of the first direction side sensor 601. When the plurality of feature portions C0 are extracted, the landing position X2 of the black droplet 37K at the position of each feature portion CC is acquired. When the feature portion CC is not present in the portion in which the printed image IM0 is formed in the second main scan S2, the landing position X2 is not acquired.

As described above, the controller 10 controls the timing at which the printing head 30 is caused to eject the droplets 37 in the second main scan S2 so that the deviation of the landing position X2 in the main scan direction D1 of the droplet 37 ejected from the nozzle array 33 between the first main scan S1 and the second main scan S2 is reduced, based on the landing position X2 in the main scan direction D1 detected by the second direction side sensor 602 in the first main scan S1.

Next, the controller 10 obtains the distance ΔX1 from the ejection position X1 to the landing position X2 for the feature portion C0, and sets the adjustment value ΔX corresponding to the distance ΔX1, in the ejection timing adjustment unit 16 (S212). When a plurality of distances are determined, the controller 10 may set the average value of the plurality of distances as the adjustment value ΔX, or may set the adjustment value ΔX for each divided area. When the feature portion C0 is not present in the portion in which the printed image IM0 is formed in the second main scan S2, the adjustment value ΔX is not changed.

The controller 10 repeats the processing of S206 to S212 until the formation of the printed image IM0 is completed (S214). When the process of S206 is performed again, the landing position X2 in the first main scan S1 approaches the landing position X2 in the second main scan S2 for the feature portion C0, and the printed image IM0 is formed on the band BC corresponding to the first main scan S1 due to the ejection of the droplet 37. When the adjustment value ΔX is set for each divided area, the landing position X2 in the first main scan S1 approaches the landing position X2 in the second main scan S2 for each feature portion C0.

As described above, the controller 10 controls the timing at which the printing head 30 is caused to eject the droplets 37 in the first main scan S1 so that the deviation of the landing position X2 in the main scan direction D1 of the droplet 37 ejected from the nozzle array 33 between the second main scan S2 and the first main scan S1 is reduced, based on the landing position X2 in the main scan direction D1 detected by the first direction side sensor 601 in the second main scan S2.

When the formation of the printed image IM0 is completed, the controller 10 ends the printing control processing illustrated in FIG. 16.

As described above, in the main scan direction D1, the landing position X2 of the droplet 37 in the second main scan S2 of the return route is matched with the landing position X2 of the droplet 37 in the first main scan S1 of the outward route, and the landing position X2 of the droplet 37 in the first main scan S1 of the outward route is matched with the landing position X2 of the droplet 37 in the second main scan S2 of the return route. Therefore, deterioration in the image quality of the printed image IM0 due to change in the landing position X2 of the droplet 37 during use of the printing device 1 that performs bidirectional printing is further curbed.

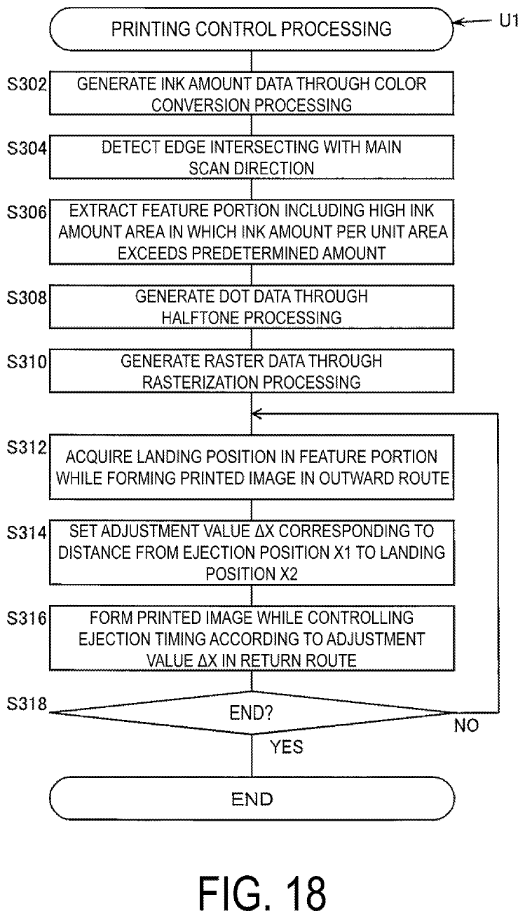

Further, as illustrated in FIGS. 17 and 18, the feature portion C0 extracted from the image data may include a high ink amount area in which an ejection amount of the liquid 36 per unit area is large. FIG. 17 schematically illustrates a feature portion C0 including the fourth feature area A4 which is a high ink amount area. In FIG. 17, an example in which the printed image IM0 is formed in the band B1 in the first main scan S1 of the outward route, and the printed image IM0 is formed in the band B2 in the second main scan S2 of the return route which is the next main scan S0 is illustrated. FIG. 18 schematically illustrates the printing control processing for reducing the deviation of the landing position X2 at the position of the feature portion C0 including the fourth feature area A4.

The fourth feature area A4 is an area in which a number of droplets 37 larger than the predetermined amount per unit area land on the medium ME0 continuously in the main scan direction D1 from the switching portions SW1 and SW2 in which the ejection state of the droplet 37 changes between ejection and non-ejection in the first main scan S1. When the fourth feature area A4 is printed on the medium ME0, the undulation called cockling is likely to occur on the medium ME0 due to the influence of a large amount of droplet 37, and the deviation of the landing position X2 may be different from other locations. Therefore, with the adjustment values obtained based on the test pattern alone, it is not possible to curb deterioration in the image quality of the printed image IM0 due to change in the landing position X2 of the droplet 37 during the use of the printing device 1.

The ejection amount of liquid 36 per unit area in the fourth feature area A4 can be expressed by the number of droplets 37 that land per pixel. When the size of the droplet 37 can change, the number of droplets 37 is a number converted to the largest size. For example, when the number corresponding to a predetermined amount is one droplet per pixel, an area in which there is more than one droplet per pixel is extracted as the feature portion C0 including the fourth feature area A4. For example, when a plurality of droplet 37 with different colors land on the same pixel PX0, this may become the fourth feature area A4.

When the printing control processing illustrated in FIG. 18 starts, the controller 10 performs the color conversion processing for converting the original image data DA1 into the ink amount data DA2 in the color conversion unit 12 (S302). Although not illustrated, the controller 10 may acquire the letter range information indicating the range of the letter LE1 from the original image data DA1.

Next, the controller 10 detects the edge E0 intersecting with the main scan direction D1 from the ink amount data DA2 (S304). The ink amount data DA2 is not limited to the K ink amount data DA2k, and may be ink amount data with colors other than K.

Next, the controller 10 extracts the feature portion C0 including the fourth feature area A4, which is a high ink amount area continuously in the main scan direction D1 from the switching portions SW1 and SW2, based on the edge E0 and the ink amount data DA2 (S306). For example, in the main scan direction D1, the number of droplets 37 per pixel converted from the ink amount data DA2 in the area from the first switching portion SW1 to the second switching portion SW2 is larger than the number corresponding to a predetermined amount, the controller 10 can discriminate the area as the fourth feature area A4. When the controller 10 acquires the letter range information, the controller 10 may not set the letter LE1 as the feature portion C0 based on the letter range information.

Next, the controller 10 performs, in the halftone processing unit 13, halftone processing for converting the ink amount data DA2 into dot data DA3, for each color (S308).

Next, the controller 10 generates raster data RAO by performing the rasterization processing (S310).

After the rasterization process, the controller 10 causes the printing head 30 to eject the droplets 37 at a timing according to the raster data RAO in the first main scan S1 of the outward route, and acquires the landing position X2 (see FIG. 2) of the droplets 37 at the position of the feature portion C0 based on the detection result of the sensor 60 (S312). Next, the controller 10 obtains the distance ΔX1 from the ejection position X1 to the landing position X2 for the feature portion C0, and sets the adjustment value ΔX corresponding to the distance ΔX1, in the ejection timing adjustment unit 16 (S314). Next, the controller 10 causes the printing head 30 to eject the droplet 37 at the timing according to the raster data RAO while performing control into the timing according to the adjustment value ΔX in the second main scan S2 of the return route in the ejection timing adjustment unit 16 (S316).

As described above, the controller 10 controls the timing at which the printing head 30 is caused to eject the droplets 37 in the second main scan S2 so that the deviation of the landing position X2 of the droplet 37 ejected from the nozzle array 33 in the main scan direction D1 between the first main scan S1 and the second main scan S2 is reduced, based on the landing position X2 in the main scan direction D1 of the droplet 37 detected by the detection unit U2 at the position of the feature portion C0 including the fourth feature area A4 in the first main scan S1.

The controller 10 repeats the processing of S312 to S316 until the formation of the printed image IM0 is completed (S318). When the formation of the printed image IM0 is completed, the controller 10 ends the printing control processing illustrated in FIG. 18.

The fourth feature area A4 on which a number of droplets 37 larger than the predetermined amount per unit area land on the medium ME0 is used as the target of reduction in the deviation of the landing position X2, such that the deviation of the landing position X2 is reduced and the image quality of the printed image IM0 can be improved even when an undulation occurs in the medium ME0.

### (5) Conclusion

As described above, according to the present disclosure, in various aspects, it is possible to provide, for example, a technology capable of curbing the deterioration in the image quality of the printed image due to change in the landing position of the droplets during the use of the printing device. Of course, the basic operation and effects described above can be obtained even with a technology configured only of constituent elements according to the independent claims.

Further, a configuration in which the configurations disclosed in the above-described examples are replaced with each other or the combinations are changed, a configuration in which a known technology and each of the configurations disclosed in the above-described examples are replaced with each other or the combinations are changed, or the like can be implemented. The present disclosure also includes these configurations.

What is claimed is:

1. A printing device for forming a printed image on a medium based on image data, the printing device comprising:
a printing head including a nozzle array in which a plurality of nozzles configured to eject a droplet onto the medium are aligned;
a control unit configured to control
a main scan in which the printing head is moved along a main scan direction intersecting with an alignment direction of the plurality of nozzles,
a sub-scan in which at least one of the medium or the printing head is moved along a feeding direction intersecting with the main scan direction, and
the ejection of the droplet from the printing head; and
a detection unit including a sensor configured to detect a density of a location on the medium at which the droplet ejected from the nozzle array during the main scan lands while moving along the main scan direction together with the print head, the detection unit being configured to detect a landing position in the main scan direction of the droplet ejected from the nozzle array based on a detection result of the sensor, wherein
the control unit controls a plurality of the main scans involving the ejection of the droplet and the sub-scan between the plurality of main scans, based on the image data,
the plurality of main scans includes a first main scan and a second main scan subsequent to the first main scan, and
the control unit controls, based on the landing position in the main scan direction detected by the detection unit in the first main scan, a timing at which the printing head is caused to eject the droplet in the second main scan to reduce a deviation in the landing position in the main scan direction of the droplet ejected from the nozzle array between the first main scan and the second main scan.

2. The printing device according to claim 1, wherein the control unit performs control to cause the second main scan to be performed after the first main scan in the plurality of main scans involving the ejection of the droplet.

3. The printing device according to claim 1, wherein
the control unit moves the printing head in a first direction in the first main scan, and moves the printing head in a second direction opposite to the first direction in the second main scan and
the sensor is at a position toward the second direction from the printing head.

4. The printing device according to claim 1, wherein
the control unit moves the printing head in a first direction in the first main scan, and moves the printing head in a second direction opposite to the first direction in the second main scan,
the plurality of main scans involving the ejection of the droplet alternately include the first main scan and the second main scan,
the sensor includes a first direction side sensor at a position toward the first direction from the printing head, and a second direction side sensor at a position toward the second direction from the printing head,
the control unit controls, based on the landing position in the main scan direction detected by the second direction side sensor in the first main scan, a timing at which the printing head is caused to eject the droplet in the second main scan to reduce the deviation in the landing position in the main scan direction of the droplet ejected from the nozzle array between the first main scan and the second main scan, and
the control unit controls, based on the landing position in the main scan direction detected by the first direction side sensor in the second main scan, a timing at which the printing head is caused to eject the droplet in the first main scan to reduce the deviation in the landing position in the main scan direction of the droplet ejected from the nozzle array between the second main scan and the first main scan.

5. The printing device according to claim 1, wherein
the control unit extracts a feature portion from which the landing position is detectable, from a portion of the image data of which the printed image is to be formed in the first main scan and
the control unit controls, based on the landing position in the main scan direction detected by the detection unit at a position of the feature portion in the first main scan, the timing at which the printing head is caused to eject the droplet in the second main scan to reduce the deviation in the landing position in the main scan direction of the droplet ejected from the nozzle array between the first main scan and the second main scan.

6. The printing device according to claim 5, wherein
the control unit moves the printing head in a first direction in the first main scan, and moves the printing head in a second direction opposite to the first direction in the second main scan,
the feature portion includes a switching portion that couples a portion in which the printed image is formed in the first main scan to a portion in which the printed image is formed in the second main scan and in which an ejection state of the droplet changes from ejection to non-ejection in the first main scan and changes from non-ejection to ejection in the second main scan, and
the control unit controls, based on the landing position in the main scan direction detected by the detection unit at a position of the switching portion in the first main scan, the timing at which the printing head is caused to eject the droplet in the second main scan to bring the landing position in the main scan direction of the switching portion in the second main scan closer to the landing position in the main scan direction of the switching portion in the first main scan.

7. The printing device according to claim 6, wherein
the feature portion includes a first feature area in which the number of droplets landing on the medium continuously in the second direction from the switching portion in the first main scan is larger than a first threshold value and
for the switching portion coupled to the first feature area, the control unit controls, based on the landing position in the main scan direction detected by the detection unit at the position of the switching portion in the first main scan, the timing at which the printing head is caused to eject the droplet in the second main scan to bring the landing position in the main scan direction of the switching portion in the second main scan closer to the landing position in the main scan direction of the switching portion in the first main scan.

8. The printing device according to claim 5, wherein the control unit does not extract a letter in the image data as the feature portion.

9. The printing device according to claim 5, wherein
the feature portion includes a second feature area in which the number of droplets landing on the medium continuously in the feeding direction in the switching portion in which the ejection state of the droplet changes between ejection and non-ejection in the first main scan is larger than a second threshold value and
the control unit controls, based on the landing position in the main scan direction detected by the detection unit at a position of the second feature area in the first main scan, the timing at which the printing head is caused to eject the droplet in the second main scan to reduce the deviation in the landing position in the main scan direction of the droplet ejected from the nozzle array between the first main scan and the second main scan.

10. The printing device according to claim 5, wherein
the feature portion includes a third feature area that couples a portion in which the printed image is formed in the first main scan to a portion in which the printed image is formed in the second main scan and in which the number of droplets landing on the medium continuously in the feeding direction in the switching portion is larger than a third threshold value, the switching portion being a portion in which the ejection state of the droplet changes between ejection and non-ejection in the second main scan, and
the control unit controls, based on the landing position in the main scan direction detected by the detection unit at a position of the third feature area in the first main scan, the timing at which the printing head is caused to eject the droplet in the second main scan to bring the landing position in the main scan direction of the third feature area in the second main scan closer to the landing position in the main scan direction of the third feature area in the first main scan.

11. The printing device according to claim 1, wherein
the printing head is configured to eject a black droplet having a black color as the droplet and
the control unit controls, based on the landing position of the black droplet in the main scan direction detected by the detection unit in the first main scan, the timing at which the printing head is caused to eject the droplet in the second main scan to reduce the deviation in the landing position in the main scan direction of the black droplet ejected from the nozzle array between the first main scan and the second main scan.

12. The printing device according to claim 5, wherein
the printing head is configured to eject, as the droplet, a black droplet having a black color and a color droplet with a plurality of colors configured to form a composite black and
the control unit does not extract a portion of the composite black in the image data as the feature portion.

13. The printing device according to claim 5, wherein
the feature portion includes a fourth feature area in which an amount of the droplet landing on the medium continuously in the main scan direction from the switching portion is larger than a predetermined amount per unit area, the switching portion being a portion in which the ejection state of the droplet changes between ejection and non-ejection in the first main scan, and
the control unit controls, based on the landing position in the main scan direction detected by the detection unit at a position of the fourth feature area in the first main scan, the timing at which the printing head is caused to eject the droplet in the second main scan to reduce the deviation in the landing position of the droplet ejected from the nozzle array in the main scan direction between the first main scan and the second main scan.

14. A printing method for forming a printed image on a medium based on image data, the printing method comprising:
a drive step of performing a main scan in which a printing head is moved along a main scan direction intersecting with an alignment direction of a plurality of nozzles in the printing head, the printing head including a nozzle array in which the plurality of nozzles configured to eject a droplet onto the medium are aligned, and a sub-scan in which at least one of the medium or the printing head is moved along a feeding direction intersecting with the main scan direction;
a detection step of detecting a landing position of the droplet ejected from the nozzle array in the main scan direction, based on a detection result of a sensor configured to detect a density of a location on the medium on which the droplet ejected from the nozzle array during the main scan lands while moving along the main scan direction together with the printing head; and
a control step of controlling a plurality of the main scans involving the ejection of the droplet and the sub-scan between the plurality of main scans, based on the image data, wherein
the plurality of main scans include a first main scan and a second main scan subsequent to the first main scan and
the control step includes controlling, based on the landing position in the main scan direction detected in the first main scan, a timing at which the printing head is caused to eject the droplet in the second main scan to reduce a deviation in the landing position of the droplet ejected from the nozzle array in the main scan direction between the first main scan and the second main scan.
